(19) United States
(12) Patent Application Publication
(10) Pub. No.: US 2025/0016566 A1
(43) Pub. Date: Jan. 9, 2025

(54) EARLY COMMIT LATE DETECT ATTACK DETECTION

(71) Applicant: TEXAS INSTRUMENTS INCORPORATED, Dallas, TX (US)

(72) Inventor: Tomas Motos, Hamar (NO)

(21) Appl. No.: 18/749,237

(22) Filed: Jun. 20, 2024

Related U.S. Application Data
(60) Provisional application No. 63/511,768, filed on Jul. 3, 2023.

(51) Int. Cl. H04W 12/12; H04B 17/336; H04L 9/40; H04L 43/0864

(52) U.S. Cl. CPC H04W 12/12; H04L 63/1425; H04B 17/336; H04L 43/0864

(57) ABSTRACT

In an embodiment, a method includes receiving, by a first device, a first signal, determining, by the first device, a detection metric indicative of a deviation between the first signal and a reference signal, and performing, by the first device, an action based on the detection metric and a detection threshold level.

### CROSS-REFERENCE TO RELATED APPLICATIONS

This application claims the priority benefit of U.S. Provisional Patent Application No. 63/511,768, filed Jul. 3, 2023, entitled “EARLY COMMIT LATE DETECT ATTACK DETECTION,” which application is hereby incorporated herein by reference.

### TECHNICAL FIELD

The present disclosure relates generally to an electronic system and method, and, in particular embodiments, to a system and method for early commit late detect (ECLD) attack detection.

### BACKGROUND

Early commit late detect (ECLD) attacks can occur in wireless communication environments when an attacking device learns symbols of a transmitted signal early during a communication phase between two devices and commits the symbols later in the communication phase to attempt to deceive the receiving device about the arrival time of the transmitted signal, and consequently, the proximity of the transmitting device to the receiving device. In turn, if successful, the receiving device may perform an action based on the signal, such as unlocking a device (e.g., a vehicle door, a hotel door) for the attacker.

### SUMMARY

Some embodiments advantageously result in improvements to wireless transmissions.

In some embodiments, increasing the bandwidth time product (BT) during transmission of a message may advantageously reduce the symbol transmission time, which may advantageously help prevent early commit late detect (ECLD) attacks.

In some embodiments, increasing the bandwidth time product (BT) during an authentication phase may advantageously prevent early commit late detect (ECLD) attacks while authenticating or attempting to authenticate a device or signal.

In some embodiments, a lower BT is used during a communication phase, which may advantageously improve coexistence with other RF devices during the communication phase.

In some embodiments, a lower BT is used during a communication phase that occurs after an authentication phase that uses a higher BT. Using a lower BT during a communication phase that follows an authentication phase that uses a higher BT may advantageously allow for a secure communication phase with improved coexistence with other RF devices.

In some embodiments, a higher BT is used only in (e.g., some) data communication channels (e.g., used for channel sounding) while a lower BT is used on primary (e.g., advertisement) communication channels. By using a lower BT in primary communication channels, some embodiments may advantageously improve coexistence with other RF devices during the communication phase.

In some embodiments, increasing the BT for transmission during transmission of a round-trip time (RTT) packet may advantageously increase security for performing a distance measurement (e.g., using channel sounding), e.g., by preventing ECLD attacks.

In some embodiments, a higher BT advantageously results in increased distortion of a received signal during an attack. Such increased distortion may advantageously be detectable by determining a detection metric indicative of a deviation between the received signal and a reference signal.

In some embodiments, such detection metric includes or is based on a signal-to-noise ratio (SNR) of the received signal.

In some embodiments, such detection metric includes or is based on a signal strength indicator (RSSI) of the received signal.

In some embodiments, using a filter with a wider bandwidth to filter received signals with a higher BT, and using a filter with a narrower bandwidth to filter received signal with a lower BT advantageously allowed for a more optimal filtering of the received signal (e.g., versus using the same filter to filter all received signals).

In accordance with an embodiment, a method includes: receiving, by a first device, a first signal; determining, by the first device, a detection metric indicative of a deviation between the first signal and a reference signal; and performing, by the first device, an action based on the detection metric and a detection threshold level.

In accordance with an embodiment, a method includes: receiving, by a first device, a first signal from a second device; determining, by the first device, a detection metric indicative of a deviation between the first signal and a reference signal; determining, by the first device, a signal-to-noise ratio (SNR) associated with the first signal; determining that the first signal is authentic when the SNR is higher than an SNR threshold, and the detection metric is lower than a detection threshold; determining that the first signal is not authentic when the detection metric is higher than the detection threshold; in response to determining that the first signal is authentic, performing an unlock operation; and in response to determining that the first signal is not authentic, terminating communication with the second device.

In accordance with an embodiment, a device includes: a receiver circuit; and a processor configured to: receive, via the receiver circuit, a first signal; determine an anomaly detection metric associated with the first signal; and perform an action based on the anomaly detection metric exceeding a detection threshold level.

In accordance with an embodiment, a device includes: a receiver circuit; a detection circuit coupled to the receiver circuit; and an action circuit coupled to the detection circuit; where the receiver circuit is configured to receive a first signal; where the detection circuit is configured to determine a detection metric associated with the first signal; and where the action circuit is configured to perform an action based on the detection metric exceeding a detection threshold level.

In accordance with an embodiment, a method includes: identifying, by a first device, a first Bandwidth Time (BT) value; transmitting, by the first device during a first communication phase, a first signal using the first BT value; and transmitting, by the first device during a second communication phase, a second signal using a second BT value, where the second BT value is less than the first BT value.

In accordance with an embodiment, A device includes: a transmitter circuit; and a processor configured to: transmit, using the transmitter circuit, a first packet using a first Bandwidth Time (BT) value; and transmit, using the transmitter circuit during a second communication phase, a second packet with a second BT value lower than the first BT value.

In accordance with an embodiment, a method includes: receiving, by a first device a first signal; determining a detection metric associated with the first signal; performing a comparison between the detection metric and a metric threshold level to produce an anomaly result; and detecting, by the first device, an anomaly based on the anomaly result indicating that the detection metric exceeds the metric threshold level.

In accordance with an embodiment, a method includes: receiving, by a first device, a first signal; determining an attack detection metric associated with the first signal; and detecting, by the first device, an attack based on the attack detection metric exceeding a detection threshold level.

In accordance with an embodiment, a method includes: receiving, by a first device, a first signal; and in response to determining that the first signal deviates from a reference signal by more than a predetermined threshold, performing an action.

In accordance with an embodiment, a method including: transmitting, by a first device, an authentication packet during an authentication phase; receiving, by a second device, the authentication packet; determining a Normalized Attack Detection Metric (NADM) associated with the authentication packet; and detecting, by the second device, an attack when the NADM is above a predetermined NADM threshold.

In accordance with an embodiment, a wireless device including a receiver circuit configured to: receive an authentication packet; determine a Normalized Attack Detection Metric (NADM) associated with the authentication packet; and detect an attack when the NADM is above a predetermined NADM threshold.

### BRIEF DESCRIPTION OF THE DRAWINGS

For a more complete understanding of the present invention(s), and the advantages thereof, reference is now made to the following descriptions taken in conjunction with the accompanying drawings, in which:

FIGS. 1A and 1B show block diagrams of a system, according to an embodiment of the present disclosure;

FIG. 2 shows a method for communicating signals between elements of a system, according to an embodiment of the present disclosure;

FIGS. 3A and 3B show sequence diagrams of a system, according to an embodiment of the present disclosure;

FIG. 4 shows phase trajectories and instantaneous frequency deviations of 3 symbol periods, according to an embodiment of the present disclosure;

FIGS. 5A, 5B, and 5C show waveforms associated with devices of FIGS. 1A and 1B, according to embodiments of the present disclosure;

FIGS. 6A and 6B show waveforms associated with signals transmitted by a device using different Bandwidth Time product values (BTs);

FIG. 7 shows various parameters that may affect the total attack delay (TAD), according to an embodiment of the present invention;

FIG. 8 shows a table illustrating various parameters of a wireless communication channel and the associated effect on the detectability of a man-in-the-middle (MITM) attack, according to an embodiment of the present invention;

FIG. 9 shows manipulated signals when a device transmits symbols using BT=2.0and modes LE1M and LE2M;

FIG. 10 shows noise attack detection metric (NADM) curves associated with signals received by a device;

FIG. 11 shows NADM curves for modes LE1M and LE2M;

FIG. 12 shows NADM curves for different pseudonoise (PN) sequences;

FIG. 13 shows NADM curves for different receiver bandwidth (BW);

FIG. 14 shows NADM curves for different oversampling rates (OSR);

FIG. 15 shows NADM curves for a particular set of parameters, according to an embodiment of the present invention; and

FIGS. 16-23 show NADM curves for a various sets of parameters.

Corresponding numerals and symbols in different figures generally refer to corresponding parts unless otherwise indicated. The figures are drawn to clearly illustrate the relevant aspects of the preferred embodiments and are not necessarily drawn to scale.

### DETAILED DESCRIPTION

The making and using of the embodiments disclosed are discussed in detail below. It should be appreciated, however, that the present disclosure provides many applicable inventive concepts that can be embodied in a wide variety of specific contexts. The specific embodiments discussed are merely illustrative of specific ways to make and use the invention(s), and do not limit the scope of the invention(s).

The description below illustrates the various specific details to provide an in-depth understanding of several example embodiments according to the description. The embodiments may be obtained without one or more of the specific details, or with other methods, components, materials and the like. In other cases, known structures, materials or operations are not shown or described in detail so as not to obscure the different aspects of the embodiments. References to “an embodiment” in this description indicate that a particular configuration, structure or feature described in relation to the embodiment is included in at least one embodiment. Consequently, phrases such as “in one embodiment” that may appear at different points of the present description do not necessarily refer exactly to the same embodiment. Furthermore, specific formations, structures or features may be combined in any appropriate manner in one or more embodiments.

Embodiments of the present disclosure will be described in specific contexts, e.g., an early commit late detect (ECLD) attack prevention and detection for unlocking a vehicle, e.g., using Bluetooth Low Energy (BLE). Some embodiments may be used in other applications, such as for access control, e.g., in hotel rooms or businesses, as well as using other wireless communication protocols. Some embodiments may be used in applications different from access control, such as controlling a first device based on a proximity of a second device to the first device and/or for authenticating, by the first device, the second device based in part on the proximity of the second device to the first device.

ECLD attacks may be understood as a type of cyberattack on devices transmitting and receiving Bluetooth signals, for example. A malicious device attempting to commit an ECLD attack can mimic signals of one device to gain access or control of another device. For example, a malicious device can transmit copied signals from a smart phone to a vehicle to attempt to unlock the vehicle and gain access inside the vehicle. In this context, if the malicious device is successful, the vehicle may receive the copied signals and believe the signals were coming from the smart phone, or otherwise an authorized device, and perform an action based on the signals.

Existing solutions to thwarting ECLD attacks may include randomizing symbols transmitted from one device to another device, shortening pulses of the signals transmitted from one device to another device, and bounding proximity and distance to shorter values, for example. However, some of these solutions require additional circuitry components, which may increase the cost and design area of a system for access control, and/or may affect the performance of the device.

Disclosed herein are embodiments related to improved detection systems, devices, and methods for preventing and detecting ECLD attacks. In an embodiment, a first device (e.g., a vehicle) interacting with a second device (e.g., a key fob or another device acting as a key fob) detects an attack, such as an ECLD or MITM attack, based on a normalized attack detector metric (NADM) value of a receiver signal received by the first device, e.g., when the second device uses a bandwidth time product (BT), or bandwidth bit-period product, e.g., equal to 2, where NADM may be understood as a metric that is lower the closer the received signal is to the ideal signal. In some embodiments, when a signal-to-noise ratio (SNR) of the receiver signal is above an SNR threshold and the NADM value is higher than a NADM threshold, an ECLD attack is detected and an action (e.g., not authenticating the second device, not unlocking the doors, etc.) is taken in response. In some embodiments, when a receiver signal strength indicator (RSSI) of the receiver signal is above an RSSI threshold and the NADM value is higher than a NADM threshold, an ECLD attack is detected and an action (e.g., not authenticating the second device, not unlocking the doors, etc.) is taken in response.

In some embodiments, a method of preventing ECLD attacks is provided. The method includes receiving, by a first device, a first signal, determining, by the first device, a detection metric indicative of a deviation between the first signal and a reference signal, and performing, by the first device, an action based on the detection metric and a detection threshold level.

In another example embodiment, a method of preventing ECLD attacks is provided that includes receiving, by a first device, a first signal from a second device, determining, by the first device, a detection metric indicative of a deviation between the first signal and a reference signal, determining, by the first device, a signal-to-noise ratio (SNR) associated with the first signal, determining that the first signal is authentic when the SNR is higher than an SNR threshold, and the detection metric is lower than a detection threshold, determining that the first signal is not authentic when the detection metric is higher than the detection threshold, in response to determining that the first signal is authentic, performing an unlock operation, and in response to determining that the first signal is not authentic, terminating communication with the second device.

In another example embodiment, a device including a receiver circuit and a processor is provided. The processor is configured to receive, via the receiver circuit, a first signal, determine an anomaly detection metric associated with the first signal, and perform an action based on the anomaly detection metric exceeding a detection threshold level.

In another example embodiment, a device including a receiver circuit, a detection circuit, and an action circuit is provided. The detection circuit may be coupled to the receiver circuit. The action circuit may be coupled to the detection circuit. The receiver circuit may be configured to receive a first signal. The detection circuit may be configured to determine a detection metric associated with the first signal. The action circuit may be configured to perform an action based on the detection metric exceeding a detection threshold level.

In another example embodiment, a method of preventing ECLD attacks is provided. The method includes identifying, by a first device, a first Bandwidth Time (BT) value, transmitting, by the first device during a first communication phase, a first signal using the first BT value, and transmitting, by the first device during a second communication phase, a second signal using a second BT value, wherein the second BT value is less than the first BT value.

In another example embodiment, a device including a transmitter circuit and a processor is provided. The processor may be configured to transmit, using the transmitter circuit, a first packet using a first Bandwidth Time (BT) value and transmit, using the transmitter circuit during a second communication phase, a second packet with a second BT value lower than the first BT value.

In another example embodiment, a method of preventing ECLD attacks is provided that includes receiving, by a first device a first signal, determining an detection metric associated with the first signal, performing a comparison between the detection metric and a metric threshold level to produce an anomaly result, and detecting, by the first device, an anomaly based on the anomaly result indicating that the detection metric exceeds the metric threshold level.

In another example embodiment, a method includes receiving, by a first device, a first signal, determining an attack detection metric associated with the first signal, and detecting, by the first device, an attack based on the attack detection metric exceeding a detection threshold level.

In another example embodiment, a method includes receiving, by a first device, a first signal, and in response to determining that the first signal deviates from a reference signal by more than a predetermined threshold, performing an action.

In yet another example embodiment, a method is provided that includes transmitting, by a first device, an authentication packet during an authentication phase, receiving, by a second device, the authentication packet, determining a Normalized Attack Detection Metric (NADM) associated with the authentication packet, and detecting, by the second device, an attack when the NADM is above a predetermined NADM threshold.

In yet another example embodiment, a wireless device that includes a receiver circuit is provided. The receiver circuit may be configured to receive an authentication packet, determine a Normalized Attack Detection Metric (NADM) associated with the authentication packet, and detect an attack when the NADM is above a predetermined NADM threshold.

Some embodiments disclosed herein advantageously result in improvements to carly commit late detect attack prevention. Some embodiments may prevent attacks on devices and systems by manipulating signals communicated between devices such that attacks on the devices are detectable. Advantageously, systems, methods, and devices for preventing ECLD attacks may not only increase robustness of a secure device that provides access, but also reduce design area requirements and cost by utilizing existing transceiver circuitry to produce filterable distortion to detect attacks while abiding by Bluetooth communications standards and protocols.

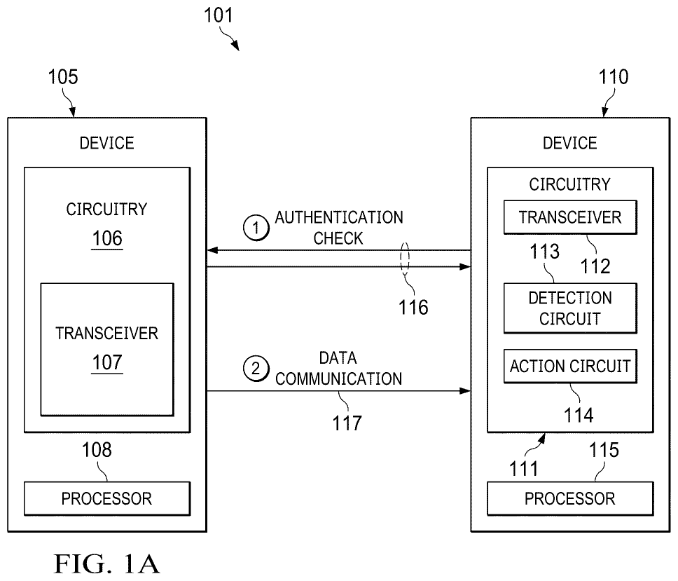

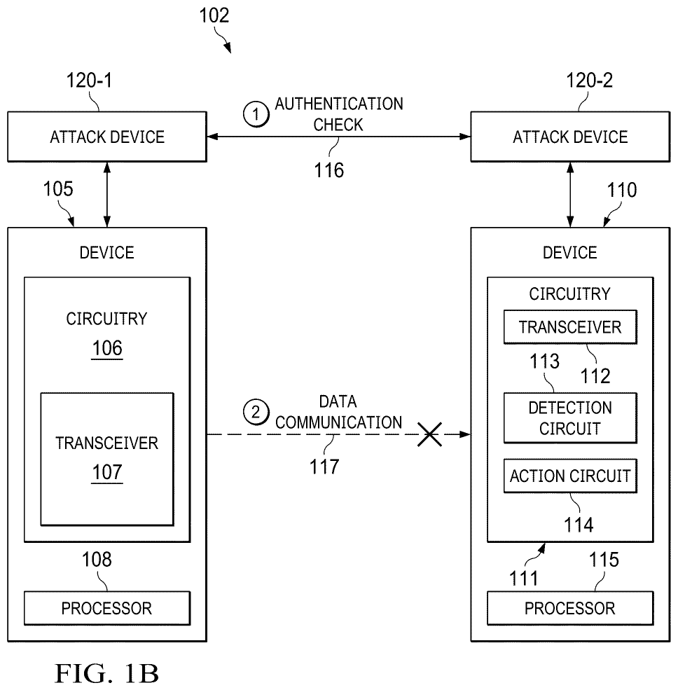

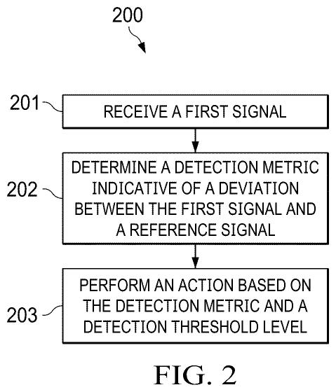

FIGS. 1A and 1B show block diagrams of a system, according to an embodiment of the present disclosure. FIG. 1A includes operating environment 101, which includes device 105, device 110, and components thereof. FIG. 1B includes operating environment 102, which also includes device 105, device 110, and components thereof, and further includes attack devices 120-1 and 120-2. Device 105 includes circuitry 106 and processor 108. Device 110 includes circuitry 111 and processor 115. In various examples, devices 105 and 110 perform early commit late detect (ECLD) attack prevention processes, such as method 200 of FIG. 2. Accordingly, devices 105 and 110 may execute such processes on hardware, software, firmware, or any combination or variation thereof.

Referring first to FIG. 1A, operating environment 101 is representative of an environment including device 105 and device 110 in wireless communication with each other. Device 105 may be representative of any device, apparatus, or system capable of transmitting and receiving signals to and from device 105 using a wireless communication protocol such as Bluetooth or BLE. For example, in some embodiments, device 105 may be a key fob or a smart phone. Similarly, device 110 may be representative of any device, apparatus, or system capable of transmitting and receiving signals to and from device 105 via the wireless communication protocol. In some embodiments, device 110 may be a vehicle, a hotel room keypad, or any other device configured to provide wireless access control. In some embodiments, the wireless communication between devices 105 and 110 uses gaussian frequency-shift keying (GFSK).

In various embodiments, devices 105 and 110 include components capable of establishing wireless communications between each other, performing actions based on signals received from each other, and preventing ECLD attacks. For example, device 105 includes circuitry 106 and processor 108, and device 110 includes circuitry 111 and processor 115.

Circuitry 106 and circuitry 111 may be representative of one or more hardware components capable of transmitting, receiving, and processing signals communicated over the wireless network. In some embodiments, examples of circuitry 106 and 111 may include communications equipment, antennas, transmit circuitry and receiver circuitry (e.g., a transceiver), logic devices, amplifiers and buffers, filters, analog-to-digital converters, and the like. Specifically, in such embodiments, circuitry 106 may include transceiver 107, and circuitry 111 may include transceiver 112, detection circuit 113, and action circuit 114. In some embodiments, additional circuitry may be included in or external to devices 105 and 110. For example, in some embodiments, devices 105 and 110 may include or use one or more antennas located externally to devices 105 and 110 (e.g., and respectively coupled to circuitry 106 and 111) to facilitate communications between device 105 and device 110.

Processors 108 and 115 may be representative of one or more processors, processing cores, processing circuits or devices, or the like capable of controlling circuitry 106 and 111, respectively, and other aspects of devices 105 and 110, respectively.

In some embodiments, each of processors 108 and 115 may be implemented as a generic or custom controller or processor coupled to a memory and capable of executing instructions stored in the memory. In some embodiments, examples of processors 108 and 115 may include one or more generic or custom microcontrollers, DSPs, general purpose central processing units, application specific processors or circuits (e.g., ASICs), and/or logic devices (e.g., FPGAs), as well as any other type of processing device, combinations, or variations thereof.

In some embodiments, processor 115 includes and/or implements the functions of detection circuit 112 and/or action circuit 114.

In some embodiments, processor 115 and circuitry 111 are part of a controller of device 110, where device 110 also includes a host (not shown) that communicates with the controller using a host-controller interface (HCI), where the host includes a processor. In such embodiments, the host and controller may be implemented in separate integrated circuits or in the same integrated circuit.

In some embodiments, processor 108 and circuitry 106 are part of a controller of device 105, where device 105 also includes a host (not shown) that communicates with the controller using an HCI, where the host includes a processor. In such embodiments, the host and controller may be implemented in separate integrated circuits or in the same integrated circuit.

In operation, devices 105 and 110, via circuitry 106 and 111 and processors 108 and 115, may perform several communication phases to establish communications between each other, authenticate each other, and provide signals and other data to each other. A first communication phase may include an authentication phase (authentication check 116). A second communication phase may include a data communication phase (data communication 117). Other communication phases may occur between devices 105 and 110, such as a signal negotiation phase, among other phases.

In operation, device 110 may initiate an authentication phase to verify that device 105 is an authorized device and that subsequently received signals are authentic signals. During the authentication procedure, devices 105 and 110 can perform authentication check 116. Authentication check 116 may begin when device 110 (or device 105 in other examples) transmits an authentication message (e.g., a message with a sequence of bits known to both devices 105 and 110) to device 105. In some embodiments, the authentication message may be or include a round-trip time (RTT) packet (e.g., the RTT packet is sent by device 110 to device 105, received by device 105 and sent back by device 105 to device 110, and received by device 110, where the time between transmitting the RTT packet by device 110 and receiving the RTT packet by device 110 may be used to determine the distance between devices 105 and 110). Device 105 may receive the RTT packet during authentication check 116 and transmit a signal, including the known bits (or data based on the known bits), to device 110. Device 105, via circuitry 106 and processor 108, may transmit the signal (e.g., an authentication packet) using a bandwidth time product (BT) having a value of 2.0. In some embodiments, in transmitting the signal using BT of 2.0, device 105 transmits the signal using pseudorandom noise (PN) sequence of 128 bits. In some embodiments, in transmitting the signal using BT of 2.0, device 105 transmits the signal using a PN sequence of a different sequence length, such as 32 bits, 64 bits, or 96 bits, among other sequence lengths (in some embodiments, the sequence length may be selectable). In this way, device 105 may transmit a distorted signal having a shorter symbol period and having a higher signal-to-noise ratio (SNR) relative to a signal transmitted using a BT product of a lower value (e.g., BT of 0.5). In some embodiments, device 105 may transmit the signal using a Bluetooth or Bluetooth Low Energy (BLE) communication protocol. In some such embodiments, device 105 may transmit the signal using Bluetooth LE2M mode. In some embodiments, device 105 may transmit the signal using Gaussian Frequency Shift Keying (GFSK).

Device 110 can receive the distorted signal, filter out the noise using circuitry 111, and determine whether the received signal is authentic or not authentic (e.g., an attack signal, an anomaly). In some embodiments, this may entail determining, via detection circuit 113, a detection metric of the received signal. Detection circuit 113 may be representative of one or more circuits or devices (e.g., a hardware accelerator) configured to receive the signal, filter the received signal, and compare the received signal with a reference signal to determine the detection metric. In some embodiments, the detection metric may be indicative of a deviation between the received signal and a reference signal including a sequence of known, predetermined bits. For example, the detection metric may be a Normalized Attack Detection Metric (NADM).

To determine the detection metric, detection circuit 113 may be configured to determine differences between the first signal and the reference signal throughout the period of transmission during the authentication phase and accumulate the differences. In some embodiments, determining the detection metric may include determining a mean square root of the received signal relative to the reference signal.

In some embodiments, detection circuit 113 may also be configured to determine a received signal strength indicator (RSSI) associated with the received signal. In some embodiments, detection circuit 113 may further be configured to determine an SNR of the received signal.

Upon determining the detection metric, detection circuit 113 may be configured to compare the detection metric to a detection threshold level. In some embodiments, the detection threshold level may be a predetermined value corresponding to a quality of the filtering capabilities of detection circuit 113. For example, the detection threshold level may correspond to an amount of distortion filterable by detection circuit 113 to determine whether the received signal is authentic or not authentic. In some embodiments, the detection threshold level may be based on a correlation between the received signal and the reference signal. In some embodiments, the detection threshold may be based on a minimum detection metric of a manipulated or anomalous signal indicative of a MITM attack on the devices. In some such embodiments, the detection threshold may include a first value of corresponding to an approximate detection value. In some embodiments, the detection threshold may include a range of values corresponding to a detection range. In some embodiments, the detection threshold may be further based on an SNR threshold and/or an RSSI threshold.

In embodiments where detection circuit 113 determines RSSI and SNR values, detection circuit 113 may be configured to compare respective values to respective threshold levels. For example, detection circuit 113 may be configured to compare the RSSI of the received signal to an RSSI threshold. Similarly, detection circuit 113 may be configured to compare the SNR of the received signal to an SNR threshold. In some such embodiments, the SNR threshold may correspond to an SNR level in accordance with Bluetooth communication protocol standards. In some such embodiments, the SNR threshold may include a value of approximately 19 dB. In some such embodiments, the SNR threshold may include a range of values between approximately 17-20 dB.

Based on determining one or more metrics associated with the received signal relative to the reference signal and comparing the one or more metrics to respective threshold levels, detection circuit 113 can generate comparison results indicative of whether the received signal is authentic or not authentic and provide the comparison results to action circuit 114.

Action circuit 114 may be representative of one or more circuits or devices capable of obtaining the comparison results, identifying values or outcomes associated with the comparison results, and performing actions based on the values or outcomes. For example, in response to obtaining the comparison results and determining that the comparison results indicate that one or more of the metrics (e.g., the detection metric) fall below respective threshold levels (e.g., the detection threshold level), action circuit 114 may be configured to perform an action corresponding to an unlocking event (e.g., unlocking a vehicle, unlocking a door, unlocking a device).

In some embodiments, in response to obtaining the comparison results and determining that the comparison results indicate that one or more of the metrics exceed respective threshold levels, action circuit 114 may be configured to refuse to perform an action. In some embodiments, action circuit 114 may be configured to not perform an unlocking action. In some embodiments, action circuit 114 may be configured to stop or terminate communications with device 105 (i.e., not authenticate device 105 and proceed to a further communication phase).

In some embodiments, determining whether to perform an action or not may instead, or in addition, entail determining the distance between devices 105 and 110 based on the arrival time (e.g., phase) of the received signal versus the transmittal time of the RTT packet from device 110 (e.g., a round trip delay (RTT) of the authentication message sent either from device 105 or device 110). In some examples, the distance may include a threshold distance range (e.g., 0 to 3 meters).

In some embodiments, if device 110 determines that the distance between devices 105 and 110 is outside the threshold distance range, device 110 may determine not to perform an action irrespective of whether the received signal is authentic or not. In some embodiments, if device 110 determines that the distance between devices 105 and 110 is within the threshold distance range, device 110 may determine to perform an action if device 110 determines that the received signal is authentic. In some embodiments, device 110 may determine that a signal is not authentic, and thus, might not perform an action even if the determined distance is within the threshold distance range.

In some embodiments, the distance determination is only performed after the received signal is determined to be authentic. In some embodiments, the distance determination is performed irrespective of whether the received signal is authentic or not. In some embodiments, distance determination is performed before determining whether the received signal is authentic or not.

By way of example, in some embodiments, device 110 may be a vehicle and device 105 may be a key fob (or a smart phone or other device acting as a key fob). Based on the time of arrival (e.g., phase) of the authentication message received by device 110 from device 105 during authentication check 116, device 110 may determine the proximity between the devices. If device 105 is closer than a predetermined threshold (e.g., 1 meter) from device 110, device 110 may take an action, such as unlock the vehicle, enable an unlocking capability of the vehicle, e.g., upon pressing a button in a handle of the vehicle, etc.

Following successful authentication of device 105, devices 105 and 110 may perform data communication 117 during a communication phase. Data communication 117 may include transmission of data and other signals from device 105 to device 110. In some embodiments, data communication 117 between devices 105 and 110 may occur continuously or irrespectively with regard to authentication check 116. Regardless of how and when data communication 117 occurs, device 105 may transmit signals during data communication 117 with a different, lower BT product relative to the signal transmitted during authentication check 116. For example, in some embodiments, during this communication phase, device 105 might not intentionally distort signals to introduce noise and delay in transmitted signals. In some embodiments, device 105, via transceiver 107, may transmit signals with a BT product lower than the BT used during the authentication phase (such as of 0.5 in an embodiment in which a BT of 2.0 is used during the authentication phase). Thus, the signals transmitted during the communication phase may have decreased noise and delay relative to signals transmitted during the authentication phase.

Referring next to FIG. 1B, operating environment 102 is representative of an environment including device 105, device 110, and attack devices 120-1 and 120-2 (collectively referred to as attack devices 120) whereby attack devices 120 attempt to wirelessly communicate with devices 105 and 110 to perform an ECLD attack on device 110.

Attack devices 120 may be representative of any device, apparatus, or system capable of communicating with devices 105 and 110 and with each other. In various examples, attack devices 120 may be referred to as a man in the middle (MITM) device that can manipulate the communication between devices 105 and 110 and cause device 110 to receive the authentication message during authentication check 116, where the authentication message appears to arrive earlier than what it would have without the actions of attack devices 120. In such examples, attack device 120-1 may be positioned in proximity to device 105, while attack device 120-2may be positioned in proximity to device 110. Attack devices 120-1 and 120-2 may be connected to each other via a physical cable or some other high-speed communication mechanism.

As shown in FIGS. 1A and 1B, scenario 102 is similar to scenario 101, but with attack devices 120 acting to relay/forward communications between devices 105 and 110. In scenario 102, devices 105 and 110 are far from each other and are outside Bluetooth communication range.

In operation, attack devices 120 can attempt to perform authentication check 116 between device 105 and device 110 via a physical link between attack devices 120 (devices 105 and 110 might be outside Bluetooth communication range or might be within Bluetooth communication range yet attack devices 120 may communicate with devices 105 and 110 using stronger signals relative to normal communications between device 105 and device 110) to attempt to gain access to device 110 via an ECLD attack.

To begin the authentication phase, device 110 can transmit a signal including an RTT packet, which can be relayed from device 110 to device 105 by attack devices 120. In response to receiving the RTT packet, device 105 can transmit an authentication signal with a bandwidth time (BT) product of 2.0. The BT product of the authentication signal may be a higher BT product relative to other signals transmitted by device 105 during other phases. Attack device 120-1 can intercept the degraded signal, attempt to predict a sequence of bits of the degraded signal (in an attempt to replicate the signal transmitted by device 105), and transmit a signal to attack device 120-2 for further transmission to device 110. More particularly, in some embodiments, attack devices 120 begin transmitting “relayed” bits before receiving them (based on a prediction), and then make an adjustment (flip the bit) if the prediction was wrong. If, because of noise based on the BT product of the authentication signal, device 120 determines that the prediction is wrong too late, then it needs to boost the flipped bit to recover from the bad prediction. The later the bad prediction is identified, the more boost the flipped bit needs, and the more distortion imparted to the signal, which makes it more recognizable.

Device 110 can receive a signal from attack devices 120 and determine whether the received signal is authentic or not authentic. Determining whether the received signal is authentic or not authentic may include determining a detection metric of the received signal. In some embodiments, determining whether the received signal is authentic or not may include determining an SNR and an RSSI of the received signal. If the detection metric, SNR, or RSSI of the received signal exceeds a respective threshold value, device 110 may determine that the received signal is not authentic. In addition, or instead, determining whether the received signal is authentic or not authentic may entail determining the distance between devices 105 and 110 based on the received signal.

In an example including attack devices 120, device 110 may utilize any of the aforementioned methods to determine that the received signal is not authentic. For example, device 110 may determine that the round trip delay time between transmitting the authentication signal and receiving the returned signal is beyond a predetermined threshold value. The delay may occur based on the BT product with which device 105 transmits the signal as attack device 120-1 may experience issues predicting and relaying the signal due to the poor signal quality. It follows that the BT product with which the signal is transmitted may also influence the detection metric, the RSSI, and/or the SNR of the signal copied by attack device 120-1. Thus, after determining that the received signal is not authentic, device 110 might not authorize access or perform an action. As a result, device 110 may further terminate data communications 117 between device 105 in some examples.

By way of example, device 110 may be a vehicle parked in a driveway of a house, and device 105 may be at the master bedroom of the house (e.g., 20 meters away from device 110). Attack devices 120 may be split into two nodes, a first node (attack device 120-1) near the master bedroom of the house (near device 105) and a second node (attack device 120-2) near the vehicle (near device 110), where the two attack devices 120 are connected via a physical cable or some other high-speed communication mechanism. When attack devices 120 receive the authentication message from device 105 (e.g., using attack device 120-1), attack devices 120 may attempt to predict the next symbol and transmit the predicted symbol to device 110 (e.g., using attack device 120-2), thereby causing device 110 to receive the authentication message earlier than the time the authentication message would have arrived without attack devices 120. Therefore, based on the shortened time of arrival, device 110 can determine that an ECLD attack has occurred and refuse to perform an action, such as unlocking one or more doors of the vehicle.

In some embodiments, the following equation may represent the signal received by device 110 when attack devices 120 do not intervene and introduce anomalies or an attack signal, where h(t) represents the transfer function of a normal over-the-air channel (e.g., which may include delay, multipath reflections, attenuations, etc.) and s(t) represents the signal transmitted by device 105:

$${r}_{1} ( t ) = h ( t ) * s ( t )$$

In some embodiments, the following equation may represent the signal received by device 110 when attack devices 120 intervene and device 110 receives signal r2(t) from attack devices 120:

$${r}_{2} ( t ) = A * {s}^{M} ( t )$$

In some embodiments, device 110 cancels or filters out most of the channel attenuation and multipath conditions. When device 110 performs attack or anomaly detection analysis (also referred to as NADM analysis) on the received signal, device 110 may avoid false positives associated with h(t) (e.g., detect r₁(t) as not being associated with an ECLD attack) and may be able to detect real attacks (e.g., detect r₂(t) as being manipulated by another device).

It may be appreciated that some examples including different systems or devices may be contemplated within this disclosure. For example, device 105 may be a hotel key, and device 110 may be a hotel room keypad. Other examples may include other electronic access control devices. Devices 105 and 110 can employ the described techniques to prevent ECLD attacks from attack devices 120 attempting to gain unauthorized access.

FIG. 2 shows a method for communicating signals between elements of a system to prevent ECLD attacks, according to an embodiment of the present disclosure. FIG. 2 includes method 200, which references elements of operating environments 101 and 102 of FIGS. 1A and 1B, respectively. In various examples, method 200 may be implemented in software, hardware, firmware, or any combination or variation thereof.

Method 200 may include a series of steps taken, e.g., by device 110, or from the perspective of device 110, during one or more communication phases occurring between device 105 and device 110. In some embodiments, method 200 may include additional or fewer steps, including one or more steps taken by device 105 or from the perspective of device 105.

In operation 201, device 110, via circuitry 111 (e.g., transceiver 112), receives, during an authentication phase, an authentication signal from device 105. Device 105 can transmit, via circuitry 106 (e.g., transceiver 107), the authentication signal using a first bandwidth time (BT) product of 2.0 in response to receiving an RTT packet sent from device 110 to initiate the authentication phase. The authentication signal may include an authentication packet with a series of bits known to both device 105 and device 110. Device 105 may transmit the signal using a BT product of 2.0, e.g., so that a MITM (e.g., attack devices 120) cannot reproduce the authentication signal sufficiently earlier and/or without substantial distortion. Increasing the BT product (e.g., from 0.5 to 2.0), may cause the symbol transition to occur faster, thereby advantageously reducing the amount of time an attacking device (e.g., 120) has to correct a failed prediction bit, thereby increasing the distortion of the signal received by device 110, thereby increasing the likelihood that an attack is detected.

In operation 202, device 110 can receive the authentication signal, filter out the noise using circuitry 111 (e.g., detection circuit 113), and determine whether the received signal is authentic or not authentic. This may entail determining a detection metric of the received signal which may be indicative of a deviation between the received signal and a reference signal having a sequence of bits known to device 110. In some embodiments, determining whether the received signal is authentic or not may also include determining an SNR and an RSSI of the received signal. In addition, or instead, determining whether the received signal is authentic or not authentic may entail determining the distance between devices 105 and 110 based on the received signal.

In operation 203, device 110 can perform an action based on the determined metrics (e.g., detection metric, SNR, RSSI, distance) and respective threshold levels. For example, if the detection metric, SNR, or RSSI of the received signal exceeds a respective threshold value, device 110 may determine that the received signal is not authentic. Similarly, if the distance exceeds a distance threshold, device 110 may determine that the received signal is not authentic. On the other hand, if the detection metric, for example, falls below the detection threshold level, device 110 may determine that the received signal is authentic. The same may be true for other metrics relative to respective thresholds. In some embodiments, device 110 may determine that the received signal is authentic based on both the detection metric and the SNR of the received signal falling below respective thresholds. Other combinations and variations may be contemplated.

Based on device 110 determining that the received signal is authentic, device 110 may perform an action including an authorization or unlocking operation. For example, device 105 may be a key fob, and device 110 may be a vehicle. In response to device 110 determining that the received signal is authentic, device 110 may perform an action that unlocks the vehicle.

Following performance of the action (e.g., authorization), devices 105 and 110 may initialize or continue performing data communications. In various embodiments, the BT product with which device 105 transmits data communications with device 110 may include a lower value, such as 0.5. It follows that data communications may utilize less noisy, faster transitioning signals.

In some embodiments, based on device 110 determining that the received signal is not authentic, device 110 may perform an action including termination of communications between devices 105 and 110, a locking operation, and the like. In some embodiments, device 110 may refuse to perform an action that includes an authorization or unlocking operation.

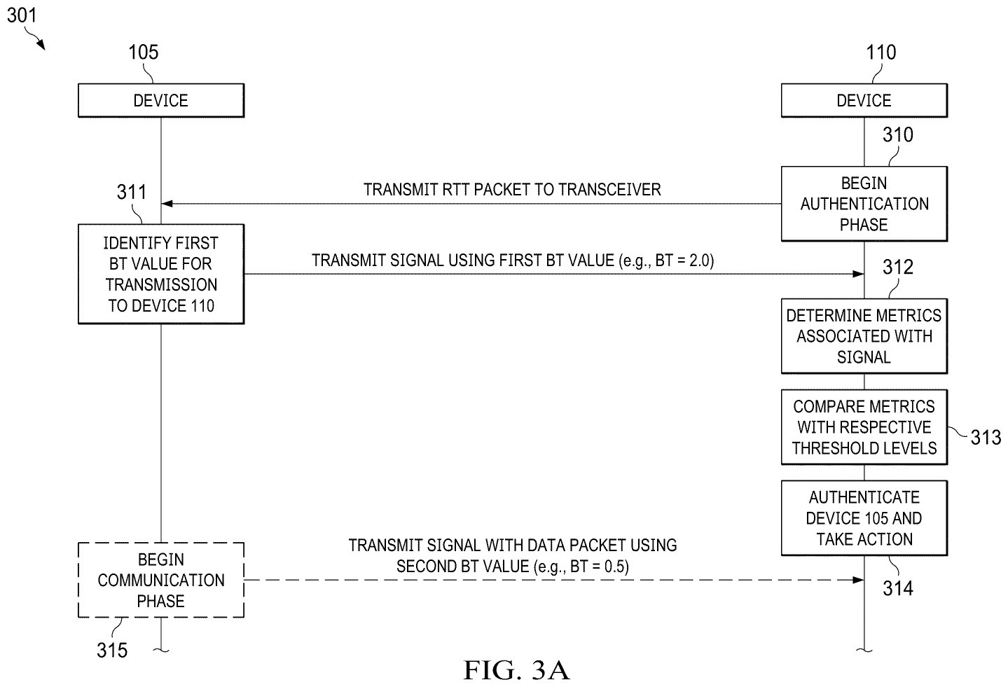

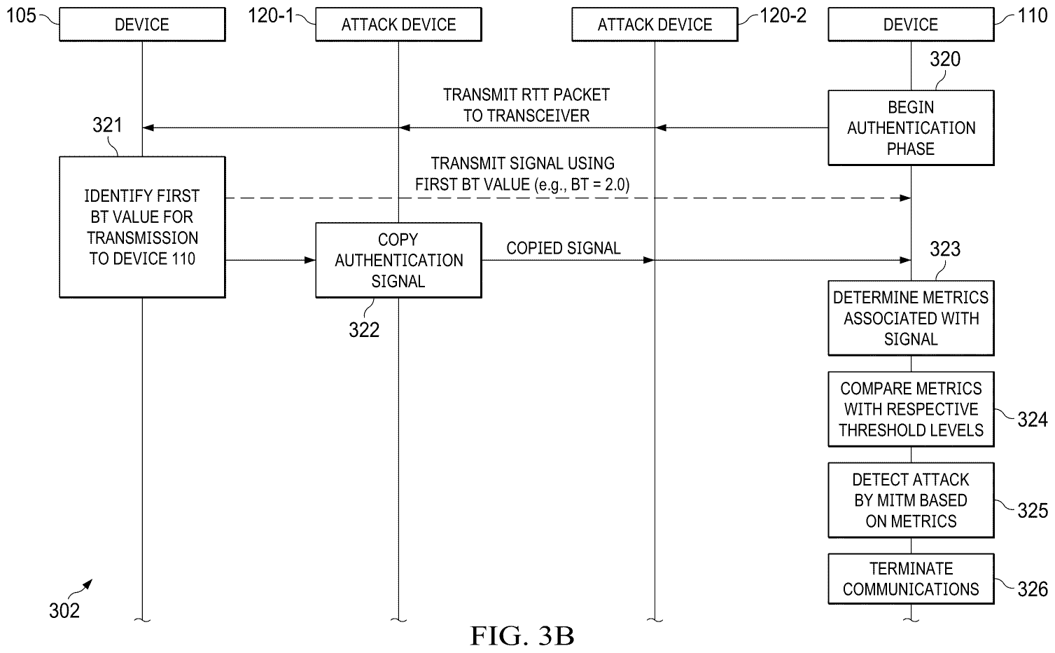

FIGS. 3A and 3B show sequence diagrams of a system, according to an embodiment of the present disclosure. FIG. 3A includes sequence 301, which references clements of operating environment 101 of FIG. 1A. FIG. 3B includes sequence 302, which references elements of operating environment 102 of FIG. 1B. Sequences 301 and 302 include a series of operations taken by elements of FIGS. 1A and 1B, respectively, which may correspond to steps of method 200 of FIG. 2.

Referring first to FIG. 3A, sequence 301 includes a series of communications and events occurring between device 105 and device 110. Sequence 301 may begin in step 310 when device 110 initiates an authentication phase to verify that device 105 is an authorized device and that subsequently received signals are authentic signals within predetermined thresholds. During the authentication phase, device 110 (or device 105 in other examples) may transmit an authentication message (e.g., a message with a sequence of bits known to both devices 105 and 110) to device 105. In some embodiments, the authentication message may be a round-trip time (RTT) packet (e.g., the RTT packet is sent by device 110 to device 105, received by device 105 and sent back by device 105 to device 110, and received by device 110, where the time between transmitting the RTT packet by device 110 and receiving the RTT packet by device 110 may be used to determine the distance between devices 105 and 110).

In step 311, device 105 may receive the RTT packet during authentication check 116, identify a first bandwidth time (BT) value with which to transmit an authentication signal, including the known bits, to device 110. The first BT value may include a BT value of 2.0 to prevent ECLD attacks.

In step 312, device 110 can receive the signal, filter out noise using circuitry 111. In some embodiments, device 110 may use a filter with a first configuration to filter signals with a BT of 0.5 and the filter (or a different filter) with a second configuration to filter signals with a BT of 2.0. Thus, in some embodiments, device 110 may use a first filter for filtering received signals during the authentication phase, and a second filter for filtering received signals during the communication phase. In some embodiments, the first filter has a wider bandwidth than the second filter.

In some embodiments, in step 312, device 110 determines whether the received signal is authentic or not authentic. This may entail determining a detection metric of the received signal which may be indicative of a deviation between the received signal and a reference signal having a sequence of bits known to device 110. In some embodiments, determining whether the received signal is authentic or not may include determining an SNR and an RSSI of the received signal. In addition, or instead, determining whether the received signal is authentic or not authentic may entail determining the distance between devices 105 and 110 based on the received signal.

In step 313, device 110 compares the metrics to respective threshold levels. For example, device 110 may compare the determined detection metric with a detection threshold level, the RSSI with an RSSI threshold, the SNR with an SNR threshold, and/or the distance with a threshold distance. For example, in some embodiments, the detection threshold may be based on a minimum detection metric of a manipulated or anomalous signal indicative of a MITM attack on the devices. In some embodiments, the SNR threshold may correspond to an SNR level in accordance with Bluetooth communication protocol standards (e.g., 19 dB). In some embodiments, the distance threshold may include a distance of approximately 3 meters.

Based on the results of the comparisons between the identified metrics and the respective threshold level, in step 314, device 110 can perform an action. For example, if the detection metric, falls below the detection threshold level, device 110 may determine that the received signal is authentic. The same may be true for other metrics relative to respective thresholds. In some embodiments, device 110 may determine that the received signal is authentic based on both the detection metric and the SNR of the received signal falling below respective thresholds. Other combinations and variations may be contemplated.

Based on device 110 determining that the received signal is authentic, and within the distance range, device 110 may perform an action including an authorization or unlocking operation. For example, device 105 may be a key fob, and device 110 may be a vehicle. In response to device 110 determining that the received signal is authentic, device 110 may perform an action that unlocks the vehicle.

Following performance of the action (e.g., authorization), in step 315, device 105 may initialize or continue performing data communications during a communication phase. In various embodiments, the BT product with which device 105 transmits data communications with device 110 may include a lower value, such as 0.5. It follows that data communications may utilize less noisy, faster transitioning signals.

Referring next to FIG. 3B, sequence 302 includes a series of communications and events occurring between device 105, device 110, and attack devices 120. In sequence 302, attack devices 120 may function as malicious MITM devices attempting to gain access to device 110.

In sequence 302, attack devices 120 can attempt to gain access to device 110 via an ECLD attack. During an authentication phase, in step 320, device 110 can transmit an RTT packet, which can be relayed (and possibly modified) from device 110 to device 105 if the two devices are not close enough to each other by attack devices 120. In response to receiving the RTT packet, in step 321, device 105 can identify a BT value with which to transmit an authentication signal to device 110, and transmit the authentication signal with the BT value identified by device 105 (e.g., BT value of 2.0). In step 322, attack device 120-1 can intercept the signal, attempt to predict a sequence of bits of the degraded signal, and transmit a modified version of the signal to attack device 120-2 for further transmission to device 110.

In step 323, device 110 can receive the signal from attack device 120-2 and determine whether the received signal is authentic or not authentic. This may entail determining a detection metric of the received signal which may be indicative of a deviation between the received signal and a reference signal having a sequence of bits known to device 110. In some embodiments, determining whether the received signal is authentic or not may also include determining an SNR and an RSSI of the received signal. In addition, or instead, determining whether the received signal is authentic or not authentic may entail determining the distance between devices 105 and 110 based on the received signal.

In step 324, device 110 compares the metrics to respective threshold levels. For example, device 110 may compare the determined detection metric with a detection threshold level, the RSSI with an RSSI threshold, the SNR with an SNR threshold, and/or the distance with a threshold distance. For example, in some embodiments, the detection threshold may be based on a minimum detection metric of a manipulated or anomalous signal indicative of a MITM attack on the devices. In some embodiments, the SNR threshold may correspond to an SNR level in accordance with Bluetooth communication protocol standards (e.g., 19 dB). In some embodiments, the distance threshold may include a distance of approximately 3 meters.

In step 325, device 110 can detect an attack by attack devices 120 based on the comparisons between the metrics and respective threshold levels. For example, if the detection metric, SNR, or RSSI of the received signal exceeds a respective threshold value, device 110 may determine that the received signal is not authentic, and thus, the received signal is an attack signal including anomalies indicative of an ECLD.

In step 326, based on device 110 determining that the received signal is not authentic and that the received signal is an attack signal, device 110 may perform an action including termination of communications between devices 105 and 110, a locking operation, and the like. In other words, device 110 may refuse to perform an action that includes an authorization or unlocking operation.

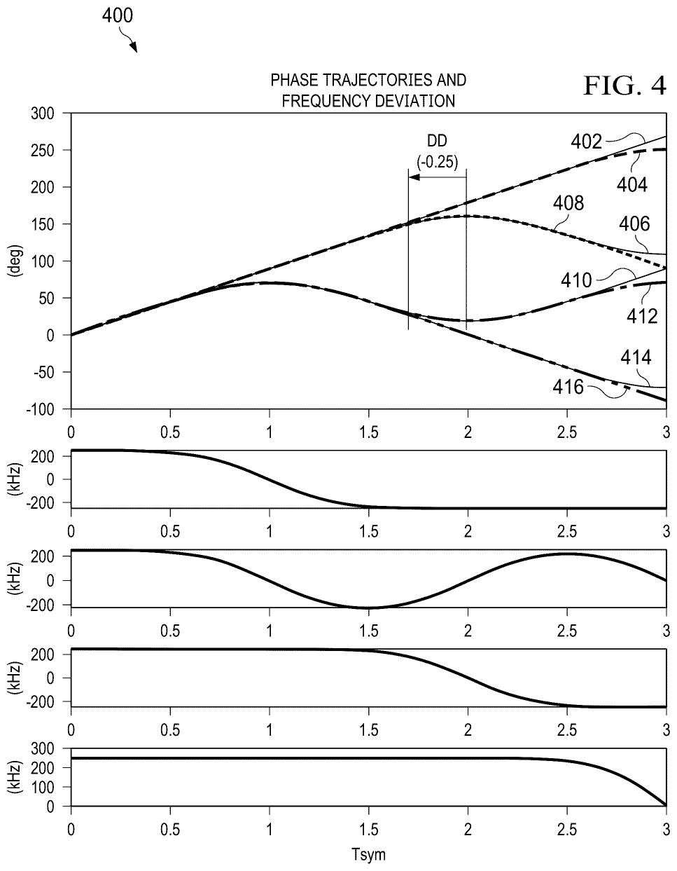

FIG. 4 shows possible phase trajectories and instantaneous frequency deviations of 3 symbol periods, according to an embodiment of the present disclosure. Curve 402 represent symbols (1, 1, 1). Curve 404 represent symbols (1, 1, 0). Curve 406 represent symbols (1, 0, 1). Curve 408 represent symbols (1, 0, 0). Curve 410 represent symbols (0, 1, 1). Curve 412 represent symbols (0, 1, 0). Curve 414 represent symbols (0, 0, 1). Curve 416 represent symbols (0, 0, 0).

As shown in FIG. 4, the last of the three symbols of any of curves 402, 404, 406, 408, 410, 412, 414 and 416 may be predicted based on the phase of the signal at the detection delay (DD) period of the second symbol. The DD period, also referred to as the attack window, may be defined from the symbol boundary (e.g., zero-crossing) and may be a negative value if the bit can be detected based on the gaussian spreading into the previous bit. The signal (r(t)) may include a message (m(t)), which represents the signal in time, may each be defined by the following equations:

$$r ( t ) = \{ {e}^{j ( 2 π {f}_{c} t + m ( t ) + {ϕ}_{n} ( t ) )} \} + i ( t ) + n ( t )$$

$$m ( t ) = π {\int }_{- ∞}^{t} {\sum }_{i = 0}^{N - 1} {α}_{i} p ( τ - i {T}_{s} ) d τ$$

In the first equation, f_{c} may be a carrier value, m(t) may be the message, Øₙ may be phase noise created by device 105, i(t) may be an interferer value, and n(t) may be noise received by device 110 or attack devices 120. In the second equation, α may represent symbols of the message, τ may represent the integration variable, p(t) may represent the gaussian shape of the message, and Tₛ may represent a period of the message.

As illustrated in FIG. 4, graphical representation 400 shows the signal in the top-most portion that includes curves 402, 404, 406, 408, 410, 412, 414, and 416, and derivatives of the signal in the bottom four portions of the graph. The phase noise, or Øₙ in the signal equation above, from device 105 may cause a shift to the right (a delay) to the attack window (making DD less negative, or more positive), which may result in more distortion in the signal received by device 110 a change (e.g., increase) in phase of the signal received by device 110.

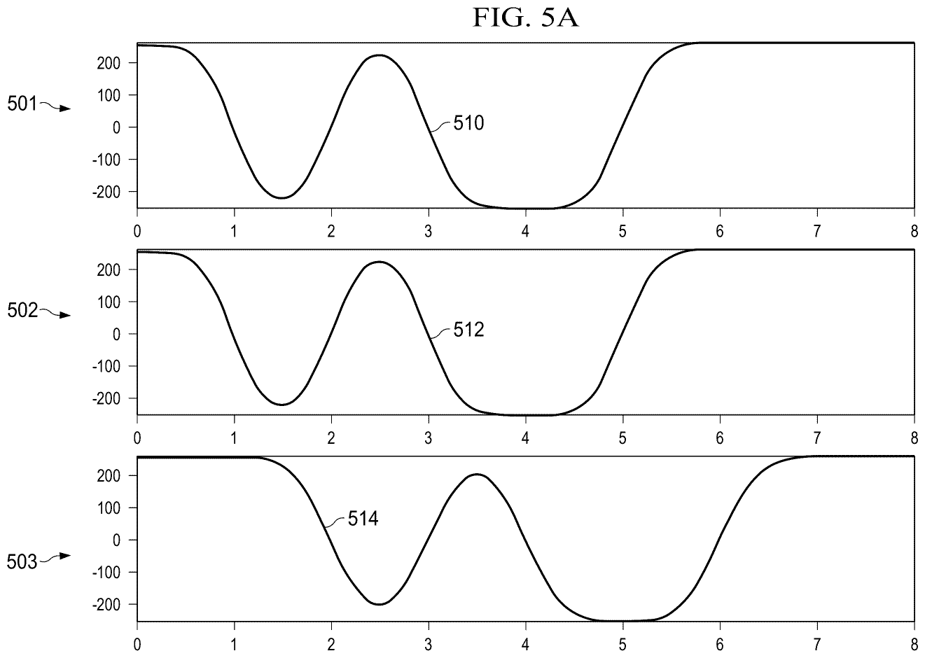

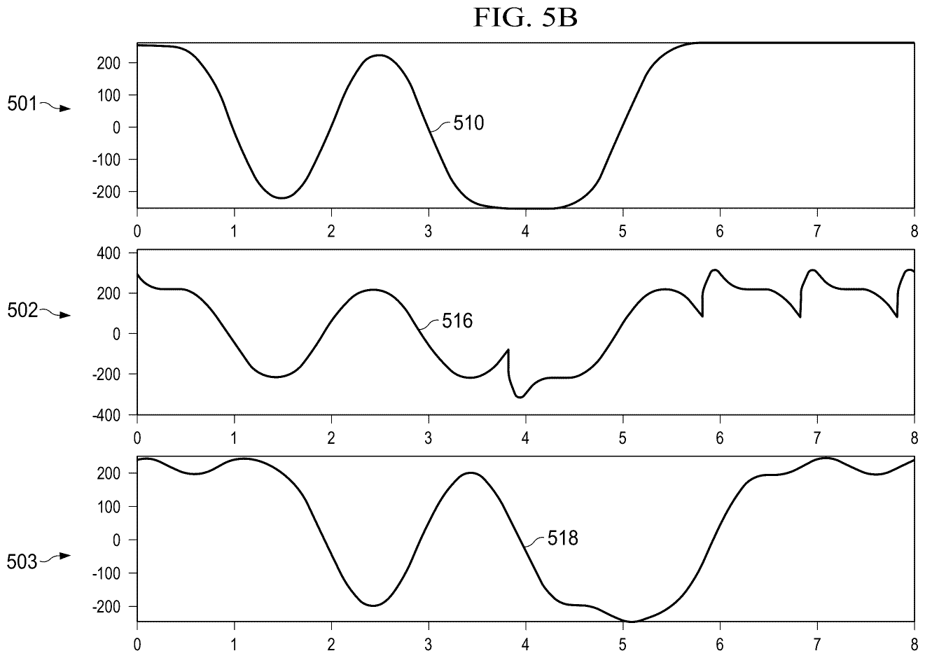

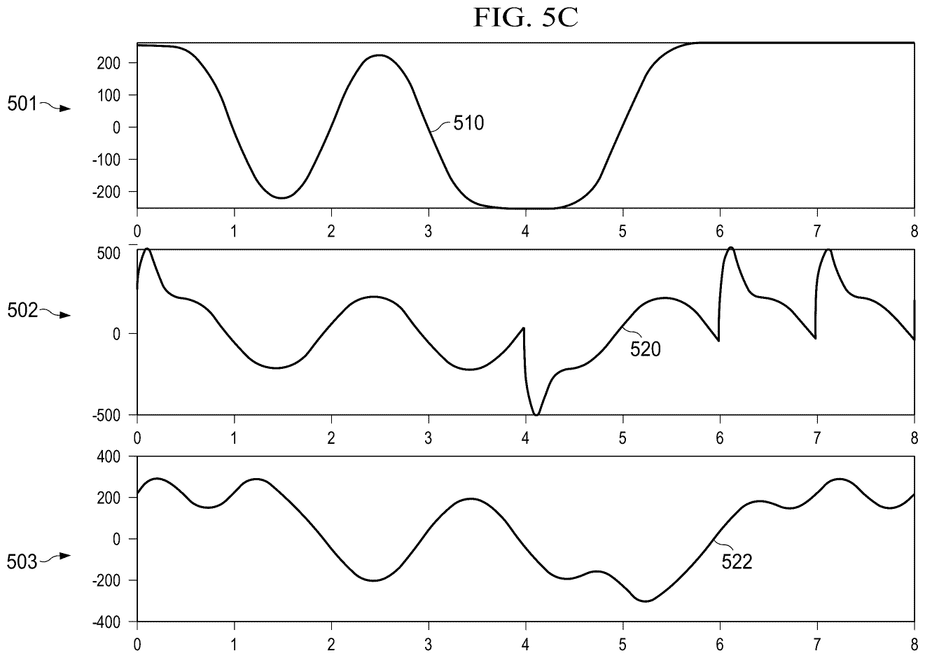

FIG. 5A shows graphical representations 501, 502, and 503, which include waveforms 510, 512, and 514, respectively, associated with device 105, attack devices 120, and device 110 of FIG. 1B, respectively, in an example where attack devices 120 do not make an attack. FIG. 5B shows graphical representations 501, 504, and 505, which include waveforms 510, 516, and 518, respectively, associated with device 105, attack devices 120, and device 110, respectively, in an example where attack devices 120 make an attack. FIG. 5C shows graphical representations 501, 506, and 507, which include waveforms 510, 520, and 522, respectively, associated with device 105, attack devices 120, and device 110, respectively, in an example where attack devices 120 make an attack. Each of the waveforms of FIGS. 5A, 5B, and 5C may represent derivatives of the message (m(t)) transmitted by device 105, transmitted by attack devices 120, and processed at device 110 (e.g., an internal signal of device 110 following filtering with a full-symbol latency filter), respectively.

Referring first to FIG. 5A, in some embodiments, waveform 510 includes a sequence of bits, such as “10100111” transmitted by device 105 to device 110. In the scenario illustrated in FIG. 5A, attack devices 120 intercepts the signal transmitted by device 105 and forwards such signal to device 110 without modifying the signal, as shown by waveform 510. Waveform 514 illustrates the signal received by device 110. As shown in FIG. 5A, waveform 514 may be shifted (e.g., due to the effect of filtering by device 110) and includes the same sequence of bits as waveforms 510 and 512, e.g., but with a single period delay as the zero-crossings of device 110 correspond to zero-crossings of device 105 (e.g., due to a full symbol latency filter).

In FIG. 5B, attack devices 120 may produce waveform 516 while attempting to predict the sequence of bits of waveform 510. In some embodiments, attack devices 120 may create the attack signal (waveform 516) from approximately 20 meters away from device 105 and with a detection delay (DD) of −0.16. As can be seen by comparing FIGS. 5A and 5B, waveform 518 (which illustrates the waveform received by device 110 after being modified by device 120) is shifted to the left with respect to waveform 512. As can be seen in FIG. 5B, the distortion introduced by attack devices 120 (e.g., by boosting the predicted signal to cause the shift in the waveform, as illustrates by waveform 516) may be filtered by device 110, thereby allowing device 110 to recreate the authentication message sent by device 105 without detecting substantial distortion, while the authentication message appears to arrive carlier, thereby causing device 105 appearing to be closer to device 110.

The longer it takes for attack devices 120 to correctly determine the next symbol, the more distortion attack devices 120 introduce to cause the authentication message to arrive carly. For example, FIG. 5C shows waveforms 510, 520, and 522 associated with device 105, attack devices 120, and device 110, respectively. FIG. 5C shows a scenario with a higher DD (compared to FIG. 5B) in which attack device is unable to detect the next symbol too carly (e.g., due to increased noise). As a result, device 120 may detect a prediction error and correct such error at a later time. For example, FIGS. 5B and 5C show a symbol prediction error at about time 4 (prediction 1; actual symbol 0), which is corrected as soon as device 120 detects such error. Because device 120 detects such error at a later time in FIG. 5C with respect to FIG. 5B (e.g., DD is −0.16 in FIG. 5B versus 0 in FIG. 5C), more distortion is introduced at about time 4 in the scenario illustrated in FIG. 5C versus the scenario illustrated in FIG. 5B (see magnitude of flipping of symbol at about time 4 in waveform 520 versus waveform 514). Such distortion may become high enough (if DD is sufficiently high, such as 0 or positive, in some embodiments) so that it becomes perceivable and detectable after filtering in device 110 (see increased distortion in waveform 522 between about times 4 and about 5.4 versus distortion in waveform 518 between about times 4 and 5.4). In some embodiments, device 110 detects the distortion of waveform 520 and, in response, refuses to take action (e.g., does not authenticate device 105, even if device 105 appears to be near device 110).

In some embodiments, device 105 changes the transition time of the symbol of the signal carrying the RTT packet (e.g., by transmitting the signal with an increased bandwidth time product (e.g., 2.0)) to prevent device 120 from predicting the symbols carly (thereby causing DD to be less negative, 0, or even positive, with respect to a non-degraded signal).

In some embodiments, device 105 dynamically (e.g., abruptly) changes the phase noise component Øₙ (and, thus, the signal-to-noise ratio (SNR)) during transmission of a packet or message (e.g., during the RTT packet).

In some embodiments, a device (e.g., device 105) may have a transmitter capable of adjusting an SNR output within a given range for modulated transmissions. In some embodiments, there are various (e.g., five or seven) different SNR levels, as shown in Table 1, and the device (e.g., device 105) may be capable of adjusting its SNR output to any of the levels.

TABLE 1

| SNR Output Index (SOI) | SNR Output Level (dB) |
|---|---|
| 0 | 18 |
| 1 | 21 |
| 2 | 24 |
| 3 | 27 |
| 4 | 30 |

In some embodiments, a device (e.g., 105 or 110) supports at least 1 of the SNR levels shown in Table 1 (e.g., level 3 may be mandatory, according to a protocol or standard), but may not support all of the levels. In some embodiments, a device (e.g., 105 or 110) may support of the SNR levels shown in Table 1. In some embodiments, before the authentication phase, selecting or identifying a BT value includes selecting a level from a predetermine list of possible levels, such as the 5 possible levels shown in Table 1. A different number of possible levels, such as 7, or more, or 4 or less is also possible.

In some embodiments, if \hat{x}(k, t) is a continuous version of the observed CS_SYNC packet transmitted by the device (e.g., device 105) at step k, \hat{φ}(k, t) is the phase of the observed \hat{x}(k, t), the lowpass filter used for the reception of CS_SYNC packet transmitted by the device (e.g., device 105) may be considered wideband.

In some embodiments, the SNR control error may be computed by:

$$S N {R}_{T X}^{e r r o r} ( k ) = \vert {SNR}_{T X}^{d e s i r e d} - S N {R}_{T X} ( k ) \vert$$

In some embodiments, device 105 changes the BT value by changing one or more settings of transceiver 107 of device 105. For example, during a communication phase between devices 105 and 110, device 105 may select a BT having a lower value relative to the BT of transmissions during the authentication phase. Such increased BT product may result in a decrease in transition time of symbols of a transmitted signal, which may advantageously increase the chances of device 110 of detecting an attack by attack devices 120, or may make it difficult for attack devices 120 to carry out the attack.

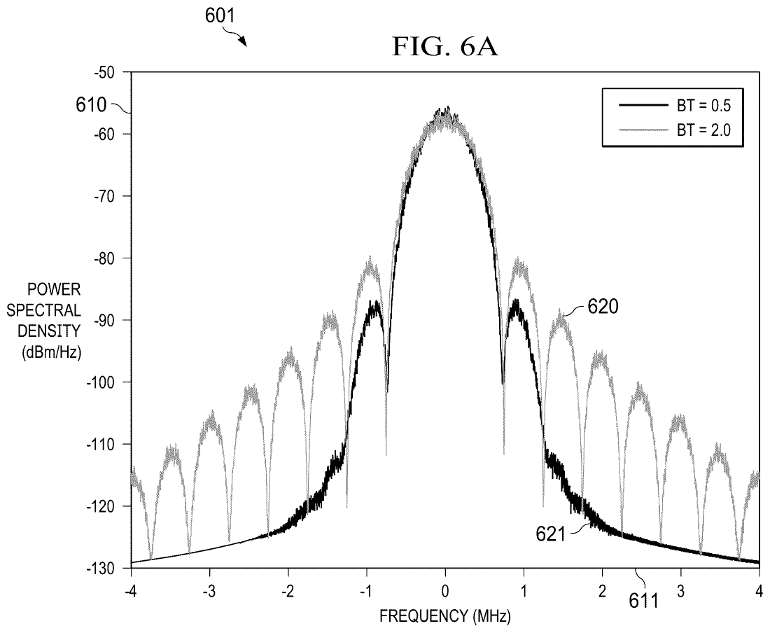

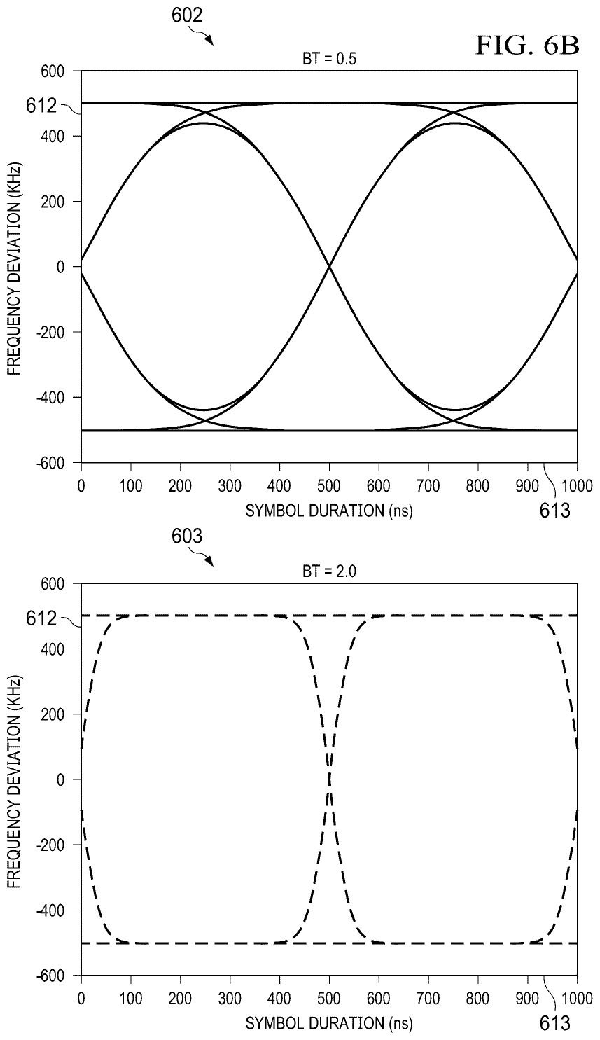

FIGS. 6A and 6B show waveforms associated with signals transmitted by a device using different Bandwidth Time product values (BTs). FIG. 6A shows waveform 601 that includes values with respect to power spectral density 610 and frequency 611, and FIG. 6B shows waveforms 602 and 603 that include values with respect to frequency deviation 612 and symbol duration 613.

In some embodiments, the BT of signals transmitted by device 105 may impact the attack window for attack devices 120 to commit an attack. For example, a BT value of 0.5 may be optimal for coexistence with other RF devices (both, LE or not) because it may minimize the energy outside the main lobe by applying filtering on the symbol transitions. However, such filtering may give an early indication of the next symbol, which may be exploited in EDLC or ECLD attacks. For example, FIGS. 6A and 6B show waveforms associated with signals transmitted by device 105 using BT of 0.5 (waveform 621) and BT of 2.0 (waveform 620). As shown in waveform 601 of FIG. 6A, a perfectly modulated GFSK signal with BT=2 has around −60 dBc at the 4 MHz mark (1 Hz RESBW).

In some embodiments, different channels of a communication protocol may use different BT values for communication. For example, in an embodiment communicating using BLE, a BT equal to 2.0 may be used on CS data channels, and not on an LE primary channels. In some embodiments, 2404 MHz and 2478 MHz are the outer channels.

As shown in FIG. 6B, the symbol transition time of signals transmitted using a BT equal to 2.0 is faster than the symbol transition time of signals transmitted using BT equal to 0.5.

In some embodiments, device 105 transmit signals using BT higher than 0.5, such as a BT of 2.0, which may advantageously allow for easier ECLD attack detection (e.g., since an attacker has less time to correct an erroneous bit prediction).

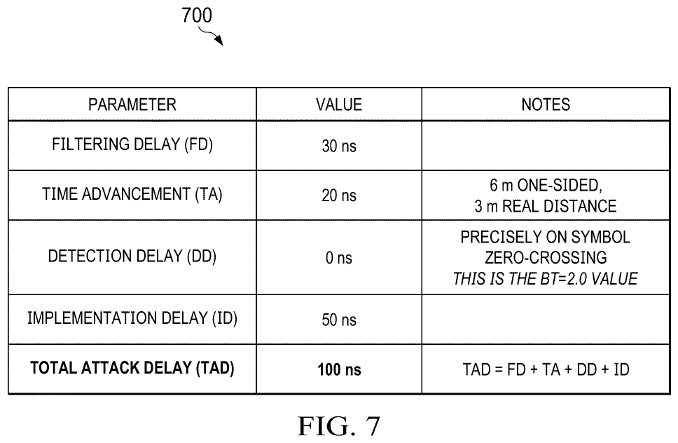

FIG. 7 shows various parameters that may affect the total attack delay (TAD), according to an embodiment of the present invention. FIG. 7 shows table 700, which includes time advancement and delay parameters, values thereof, and explanations thereof.

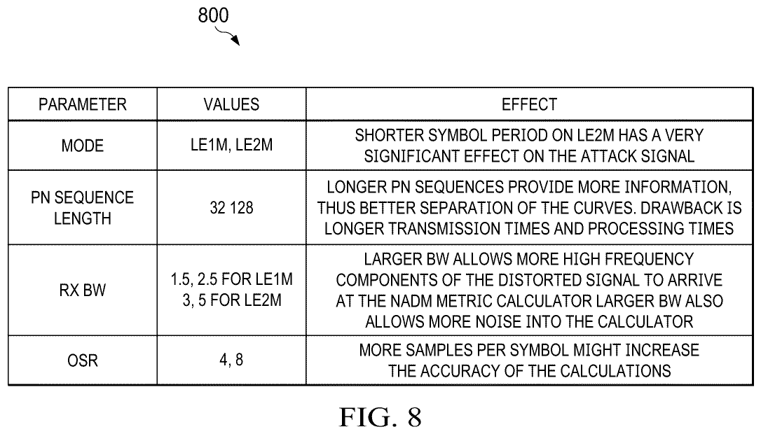

FIG. 8 shows a table illustrating various parameters of a wireless communication channel and the associated effect on the detectability of a man-in-the-middle (MITM) attack, according to an embodiment of the present invention. FIG. 8 shows table 800, which includes configurable transmission parameters and modes of device 105 and effects of the modes and parameters.

In some embodiments, in addition to BT, other parameters of the communication channel may affect the detectability of an MITM attack. For example, FIG. 8 shows table 800 illustrating various parameters of a wireless communication channel and the associated effect on the detectability of an MITM attack, according to an embodiment of the present disclosure. In some embodiments, device 105 may transmit an authentication packet, during an authentication phase, to device 110 using an LE2M mode, with a PN sequence of 128 bits, and with an oversampling rate (OSR) of 8. In some such embodiments, device 110 may include receiver circuitry (e.g., transceiver 112) capable of operating with a receiver bandwidth between 3 and 5 MHz, such as 4 MHz.

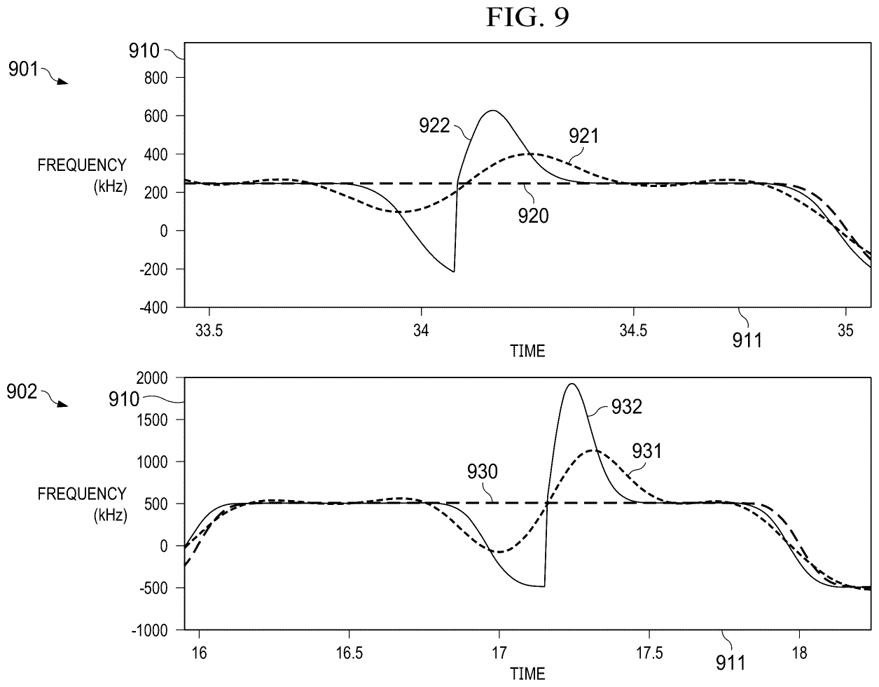

FIG. 9 shows manipulated signals when a device transmits symbols using BT=2.0 and modes LE1M and LE2M.

As an example, FIG. 9 shows graphical representations 901 and 902 that illustrate waveforms 920, 921, and 922, and waveforms 930, 931, and 932, respectively. Waveforms 920 and 930 may represent signals transmitted by device 105 using a BT of 2.0 using Bluetooth LE 1 Msym/s PHY (symbol duration=1 us) (graphical representation 901) and Bluetooth LE 2 Msym/s PHY (symbol duration=500 ns) (graphical representation 902), waveforms 921 and 931 may represent signals received by device 110, and waveforms 922 and 932 may represent signals generated by an attack device (e.g., attack devices 120-1 and/or 120-2) based on waveforms 920 and 930, respectively. In this example:
LE 1M:
   Tsym=1000 ns (1 us),
   TAD=100 ns=10% of Tsym,
   Fdev (peak-attacker)˜600 kHz (×2.4 250 kHz), and
LE 2M:
   Tsym=500 ns,
   TAD=100 ns=20% of Tsym,
   Fdev (peak-attacker)˜2000 kHz (×4 500 kHz).

As shown in FIG. 9, as the relative impact of the attack is larger in LE2M, the footprint of the attack is more visible. In some embodiments, device 105 transmit signals in LE2M mode (e.g., in addition to BT of 2).

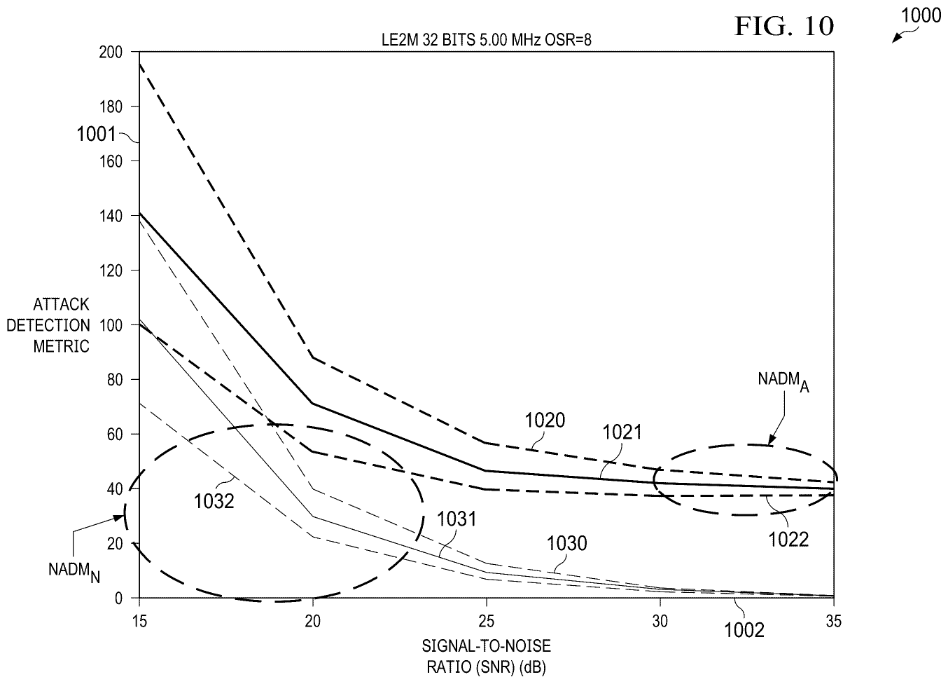

FIG. 10 shows noise attack detection metric (NADM) curves associated with signals received by a device. Specifically, FIG. 10 includes graphical representation 1000, which includes waveforms depicting non-authentic, attack signals, such as waveforms 1020, 1021, and 1022, and waveforms depicting authentic signals, such as waveforms 1030, 1031, and 1032, which include results with respect to attack detection metric 1001 and SNR 1002.

As illustrated in graphical representation 1000, the value of NADM is smaller the closer the received signal is to the ideal signal. NADM may be understood as a metric that is lower the closer is the received signal is to the ideal signal. In some embodiments, NADM performs better than the reference Pearson correlator.

As shown in FIG. 10, for high SNR 1002, and similarly, for high energy per pit relative to noise density (Eb/N0), the NADM approximates 0 (the received signal is very close to the ideal signal). When attack devices 120 manipulate a signal transmitted by device 105 before the signal is received by device 106 (e.g., such as in FIG. 1B), the NADM has a value larger than zero, as shown by waveforms 1020, 1021, and 1022. For low SNR 1002, and similarly, for low energy per bit relative to noise density (Eb/N0), the NADM also has a value larger than zero but smaller than the NADM produced when an attack is present, as shown by waveforms 1030, 1031, and 1032. In some embodiments, the parameters of the wireless communication are selected such that the NADM resulting from an attack is larger than the NADM resulting from normal operating transmissions (e.g., NADMA is larger than NADMN). In some such embodiments, a detection threshold level may be determined based on a value of NADMA.

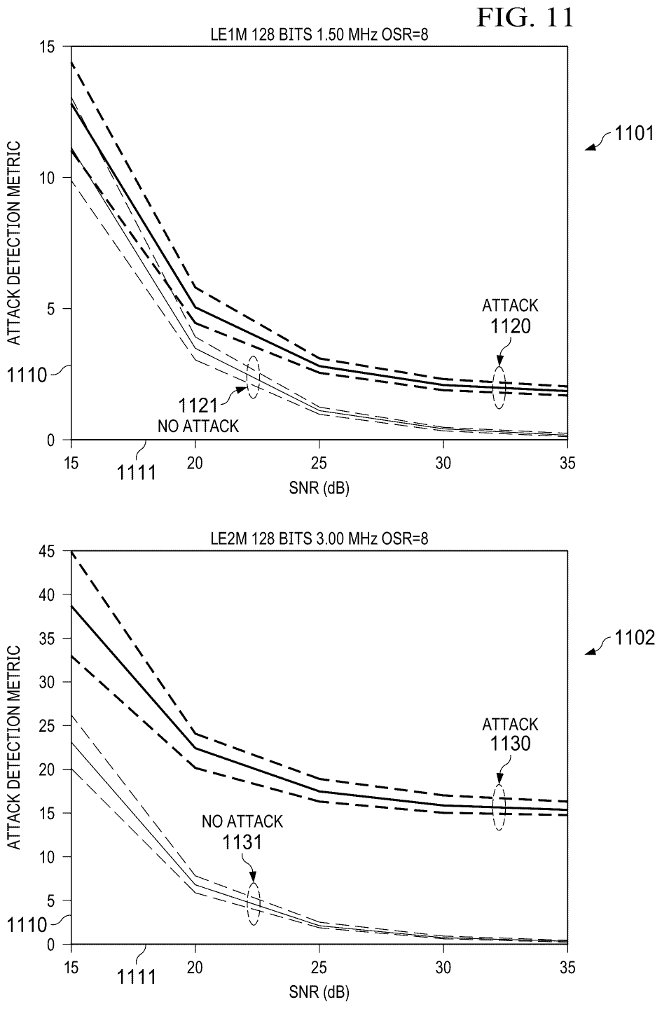

FIG. 11 shows NADM curves for modes LE1M (graphical representation 1101) and LE2M (graphical representation 1102). More specifically, graphical representation 1101 includes waveforms 1120 and 1121, which may include waveforms depicting non-authentic attack signals and authentic signals, respectively, with respect to attack detection metric 1110 and SNR 1111, and graphical representation 1102 includes waveforms 1130 and 1131, which may include waveforms depicting non-authentic attack signals and authentic signals, respectively, with respect to attack detection metric 1110 and SNR 1111.

As shown in graphical representation 1101, when using mode LE1M, the NADM curves during an attack (waveforms 1120) are very close to the NADM curves without an attack (waveforms 1121). As shown in graphical representation 1102, when using mode LE2M, the NADM curves during an attack (waveforms 1130) are far from the NADM curves without an attack (waveforms 1131). In some embodiments, mode LE2M is selected for the wireless communication, which may advantageously allow for detecting an attack based on the NADM value (i.e., a detection metric) of the received signal.

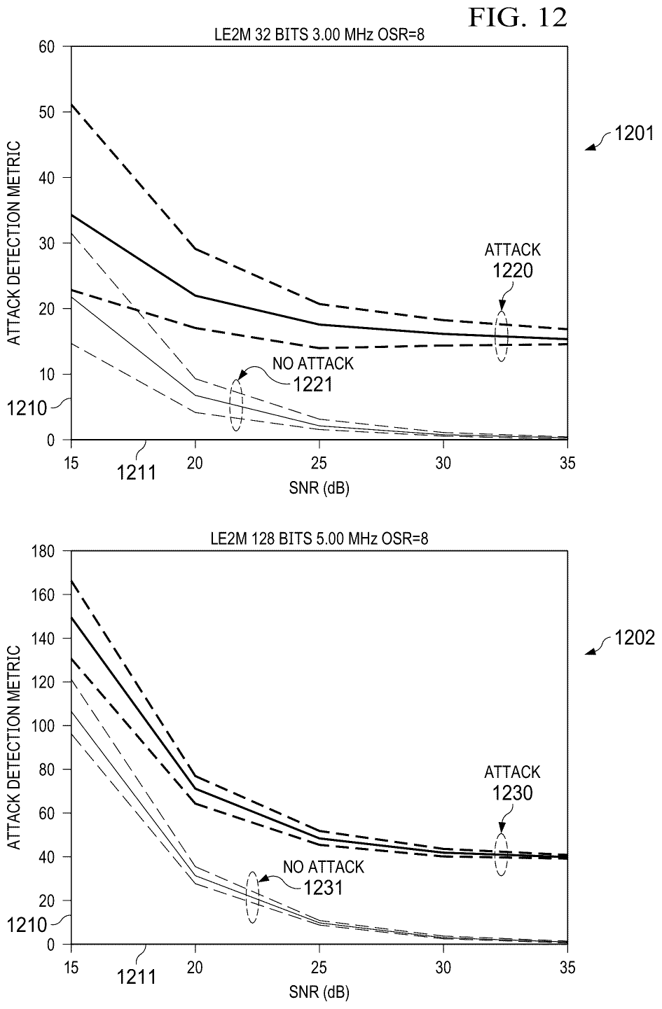

FIG. 12 shows NADM curves for different pseudonoise (PN) sequences. More specifically, FIG. 12 includes graphical representations 1201 and 1202. Graphical representation 1201 includes waveforms 1220 and 1221, which may include waveforms depicting non-authentic attack signals and authentic signals, respectively, with respect to attack detection metric 1210 and SNR 1211, and graphical representation 1202 includes waveforms 1230 and 1231, which may include waveforms depicting non-authentic attack signals and authentic signals, respectively, with respect to attack detection metric 1210 and SNR 1211.

As shown in graphical representation 1201, when using a PN sequence of 32 bits, the NADM curves during an attack (waveforms 1220) are very close (or may overlap) with the NADM curves without an attack (waveforms 1221). As shown in graphical representation 1202, when using a PN sequence of 128 bits, the NADM curves during an attack (waveforms 1230) are far from the NADM curves without an attack (waveforms 1231). In some embodiments, less available information (e.g., resulting from a shorter PN sequence) may increase the variance of the measurements and the results may become affected by noise. In some embodiments, a PN sequence of a number of bits (e.g., 128 bits, 96, bits, 64 bits, 32 bits) is selected (e.g., for secure RTT) for the wireless communication, which may advantageously allow for detecting an attack based on the NADM value of the received signal.

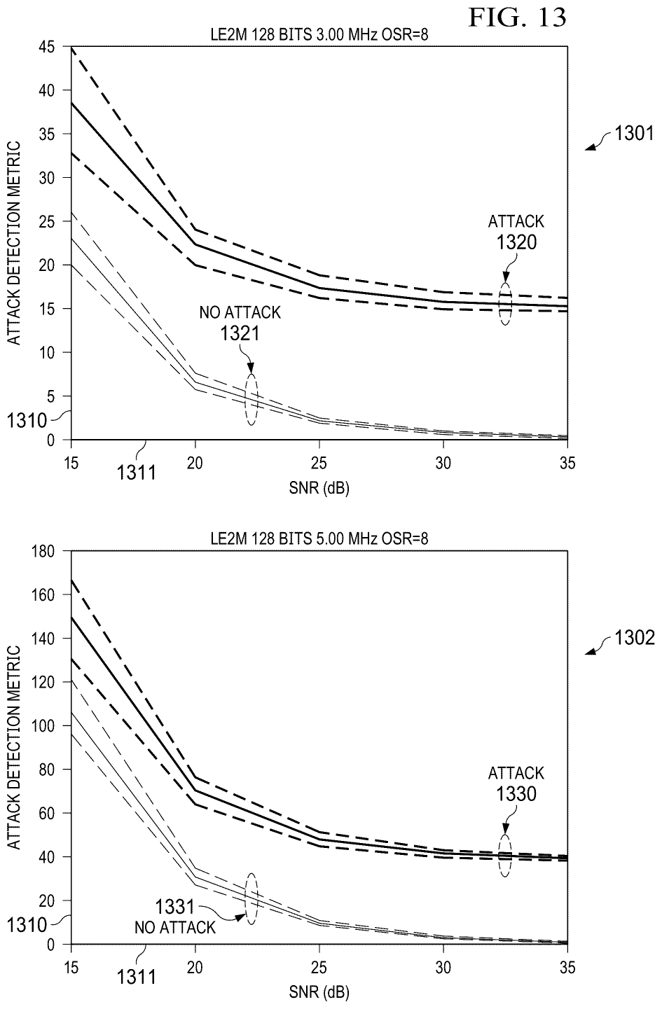

FIG. 13 shows NADM curves for different receiver bandwidth (BW). More specifically, FIG. 13 includes graphical representations 1301 and 1302. Graphical representation 1301 includes waveforms 1320 and 1321, which may include waveforms depicting non-authentic attack signals and authentic signals, respectively, with respect to attack detection metric 1310 and SNR 1311, and graphical representation 1302 includes waveforms 1330 and 1331, which may include waveforms depicting non-authentic attack signals and authentic signals, respectively, with respect to attack detection metric 1310 and SNR 1311.

As shown in graphical representation 1302, when using a BW of 5 MHz, the NADM curves during an attack (waveforms 1320) are very close to the NADM curves without an attack (waveforms 1321). As shown in graphical representation 1301, when using a BW of 3 MHz, the NADM curves during an attack (waveforms 1330) are far from the NADM curves without an attack (waveforms 1331). In some embodiments, a smaller BW reduces the separation for high SNR. However, larger BW may allow more noise into the NADM estimator for low SNR and normal communication modes, which may increase the chances of false positives. In some embodiments, the receiver bandwidth used (e.g., by device 110, e.g., during the authentication phase, such as for receiving the RTT packet) is between 3 MHz and 5 MHz, such as 4 MHz.

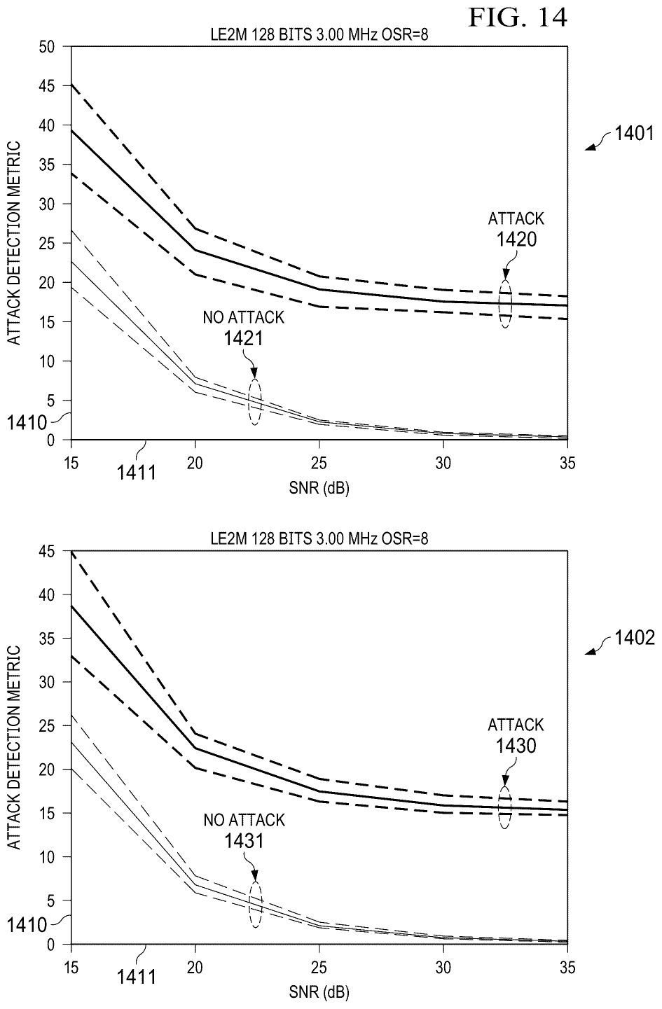

FIG. 14 shows NADM curves for different oversampling rates (OSR). More specifically, FIG. 14 includes graphical representations 1401 and 1402. Graphical representation 1401 includes waveforms 1420 and 1421, which may include waveforms depicting non-authentic attack signals and authentic signals, respectively, with respect to attack detection metric 1410 and SNR 1411, and graphical representation 1402 includes waveforms 1430 and 1431, which may include waveforms depicting non-authentic attack signals and authentic signals, respectively, with respect to attack detection metric 1410 and SNR 1411.

As shown in graphical representations 1401 and 1402, in some embodiments, increasing the OSR (once the system is already bandlimited) might not provide any significant benefit.

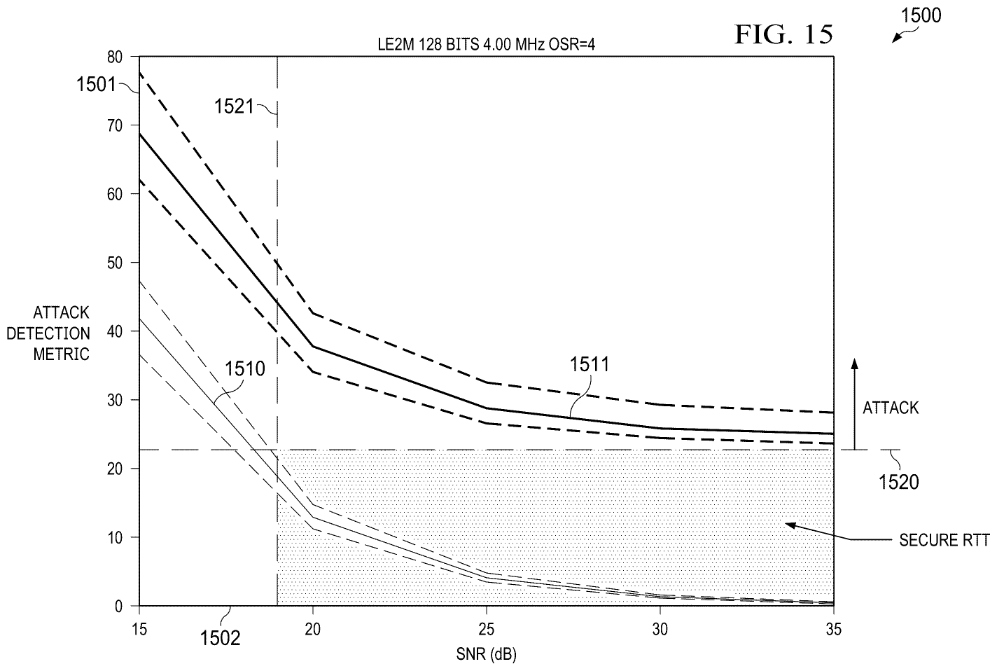

FIG. 15 shows NADM curves for a particular set of parameters, according to an embodiment of the present disclosure. FIG. 15 includes graphical representation 1500, which includes waveform 1510 and waveform 1511 with respect to attack detection metric 1501 and SNR 1502. As shown in graphical representation 1500, secure RTT may be performed using mode LE2M, a PN of 128 bits, a receiver bandwidth of approximately 4 MHz, and an OSR of 4. For example, in some embodiments, a PHY using LE2M mode and BT of 2 may impose a TAD of 20% of the symbol period. As a result, such setting may result in a noticeable distortion of the over-the-air symbols to achieve any time advancement.

As also shown in graphical representation 1500, signals with low SNR might not guarantee secure RTT at the receiver. In some embodiments, a receiver (e.g., device 110) is aware of the noise floor of the receiver and may determine if an incoming signal is above a certain threshold. In some embodiments, secure RTT may be achieved when the receiver signal has an SNR higher than a predetermined SNR threshold 1521 (e.g., about 19 dB in FIG. 15), and the NADM is below a NADM threshold 1520 (e.g., about 22 units in FIG. 15).

In some embodiments, if the SNR of the received signal is above the SNR threshold 1521 and the NADM of the received signal is above the NADM threshold 1520, an attack is detected, and an action (e.g., not authenticating a key fob or mobile device acting as a key fob, even if such device appears to be near device 110 by other metrics). For example, waveform 1511 may be representative of a NADM curve indicative of an attack on a device based on the NADM of the signal being above NADM threshold 1520.

In some embodiments, the RSSI metric may be used instead of SNR for determining the secure RTT area and when to detect an ECLD attack. For example, in some embodiments, secure RTT may be achieved when the receiver signal has an RSSI higher than a predetermined RSSI threshold, and the NADM is below a NADM threshold.

In some embodiments, the following discussion and equations may be indicative of how a detection threshold, such as NADM threshold 1520 may be determined.

In some embodiments, B may be a binary sequence of N elements in the [0,1] space where B=[b₀ . . . b_{N-1}]. Similarly, A may be a symbol sequence of N elements corresponding to the binary sequence where A=[a₀ . . . a_{N-1}] and where:

$$a [ n ] = \{ \begin{matrix}1 & when b [ n ] = 1 \\ - 1 & when b [ n ] = 0\end{matrix}$$

In some such embodiments, p(t) may be a gaussian-shaped pulse function of BT=0.5, for a normalized symbol period of 1, as defined by the following equations:

$$p ( t ) = \frac{1}{σ \sqrt{2 π}} {e}^{- 2 {( \frac{t}{σ} )}^{2}}$$

$$σ = \frac{\sqrt{ln 2}}{π}$$

And g(t) is the convolution of p(t) with a rectangle pulse of normalized duration 1, rect(t)=1 when 0<t<1 and 0 otherwise, as defined by the following equation where “*” represents a time convolution of the two signals:

$$g ( t ) = p ( t ) * rect ( t )$$

In some such embodiments, with these definitions, the reference phase is given by:

$${φ}_{r} ( t ) = \frac{π}{2} {\sum }_{i = 0}^{N} {a}_{i} {\int }_{- ∞}^{t} g ( τ - i ) d τ$$

The NADM calculation to determine NADM threshold 1520 can be performed on an incoming r(t) signal, where the nominal NADM calculation would try to measure the mean square error of that incoming signal compared to the reference signal, by the following reference operation:

$$NADM = {min}_{{τ}_{0}} {\int }_{- ∞}^{c} ‖ {φ}_{r} ( τ ) - angle ( {r}_{B} ( τ - {τ}_{0} ) ) ‖$$

Where r_{B}(t−t₀) is any arbitrary incoming signal at baseband (after removing the carrier frequency) and the t0 represents an arbitrary delay that minimizes the overall integral value and angle (r_{B}(τ−τ₀)) represents a function that returns the phase angle of a complex number.

If the incoming signal corresponds to a normal transmitter (r_{N}(t)):

$${r}_{N} ( t ) = A {e}^{j ( m ( t ) + θ ( t ) )} + n ( t )$$

### Where:

$$m ( t ) = \frac{π}{2} {\sum }_{i = 0}^{N} {a}_{i} {\int }_{- ∞}^{c} g ( τ - i ) d τ$$

Additionally, θ(t) corresponds to phase noise present in the transmitted signal and n(t) corresponds to the thermal noise present in the receiver.

Accordingly, in some embodiments, if the definition of φᵣ(t) and m(t) are identical, they correspond to the same modulation process (e.g., a normal transmitter follows the reference phase that is expected as part of the Bluetooth signal definition). For that case, after the t0 is found (which corresponds to the perfect time alignment of the reference signal and the incoming signal), then the resulting NADM equation would minimize to a very small value only containing the noise terms.

Note that, when A>>n(t):

$$angle ( {r}_{N} ( t ) ) \approx m ( t ) + θ ( t )$$

However, if an attacked r_{A}(t) signal is present at the receiver, then the output of the NADM equation may be significantly higher.

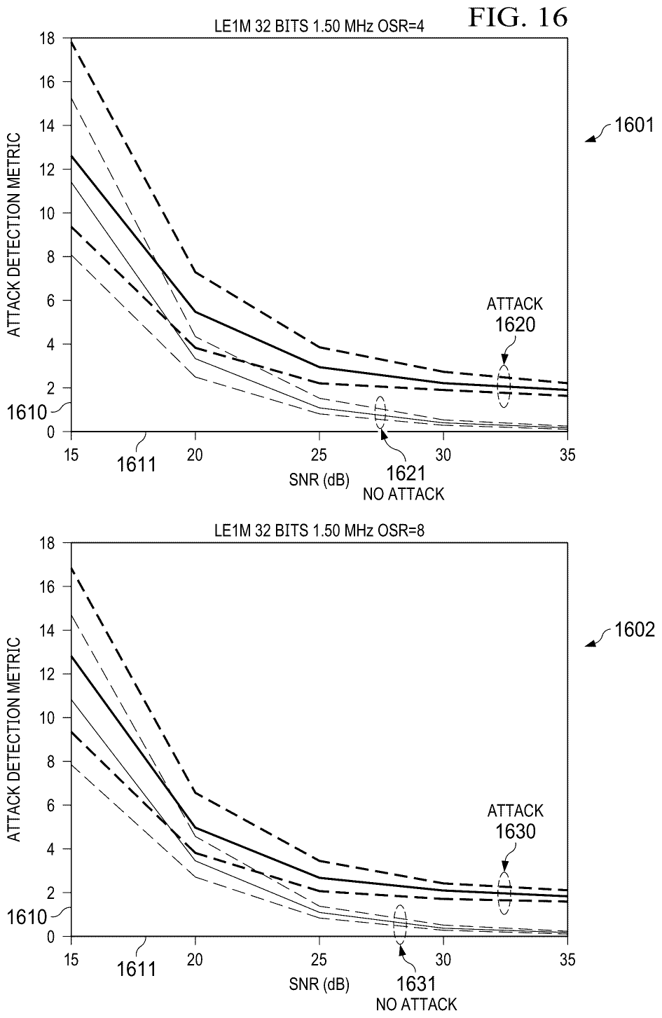

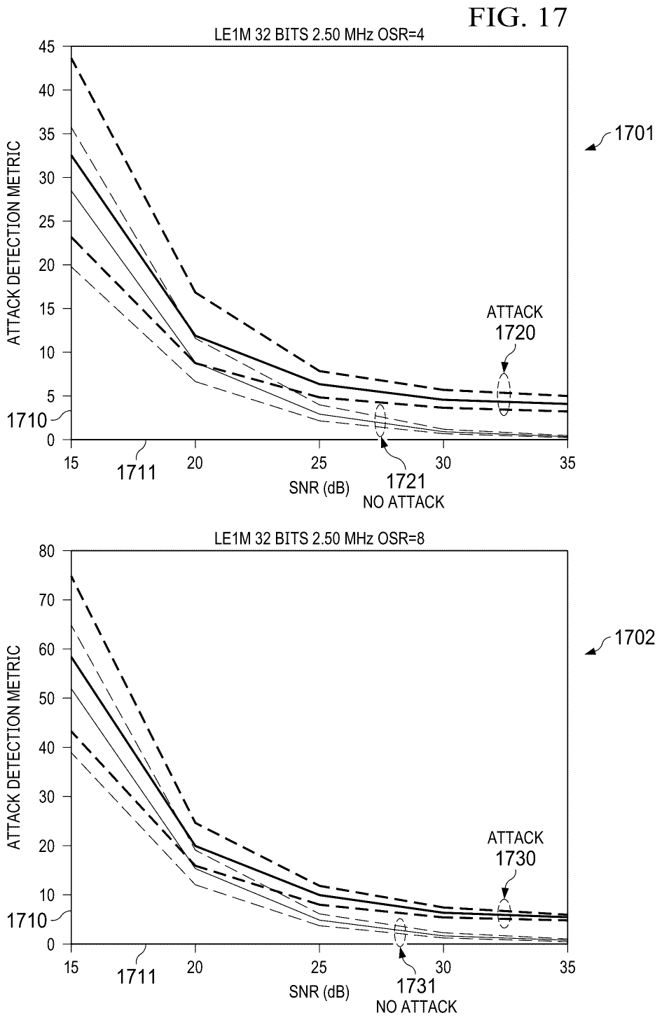

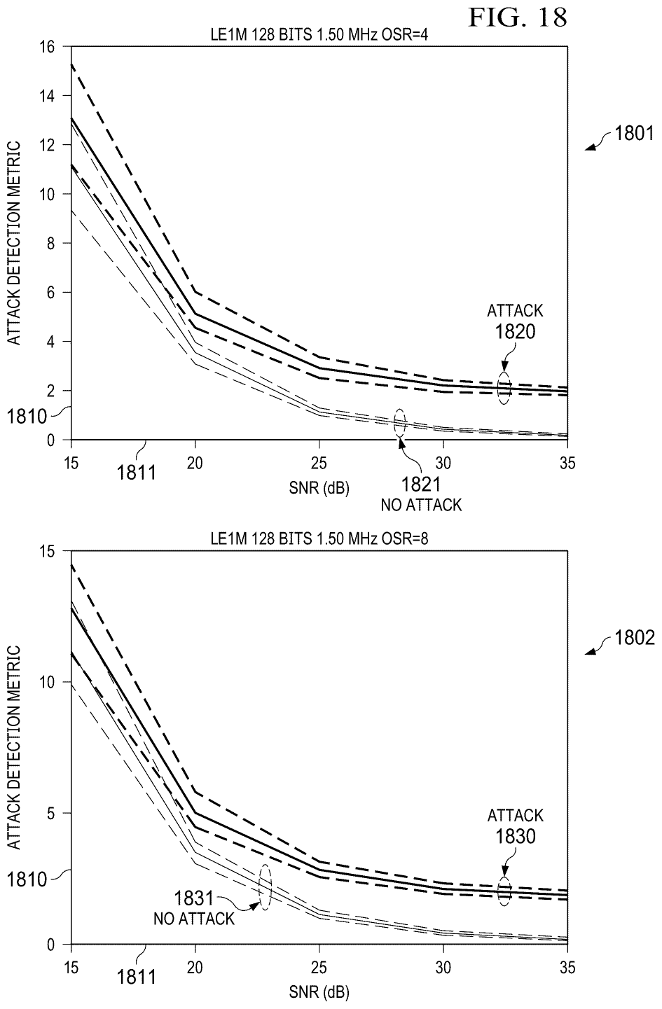

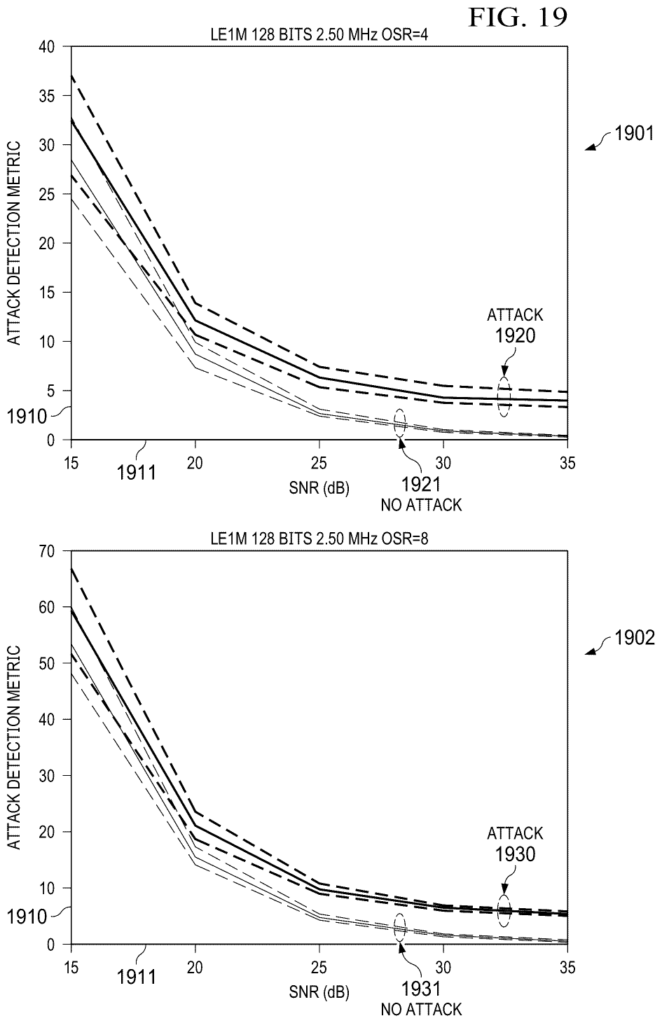

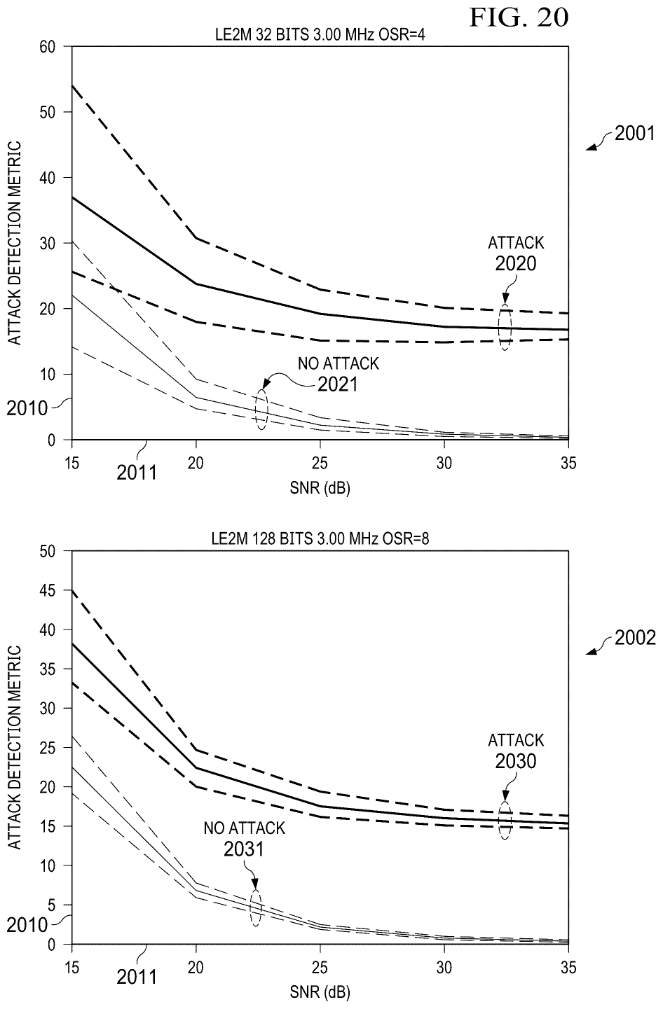

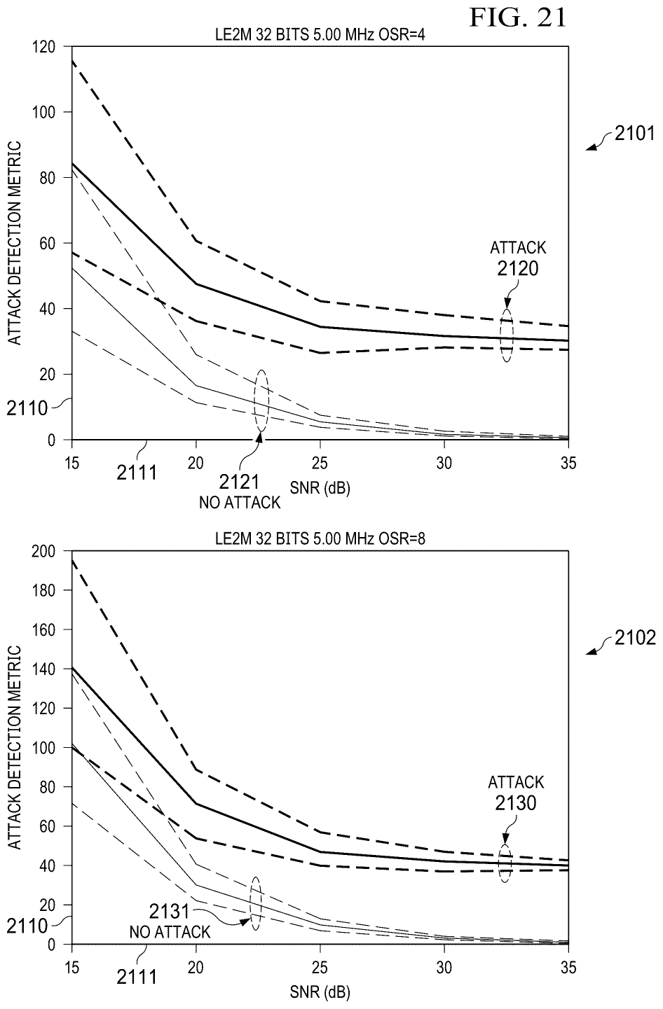

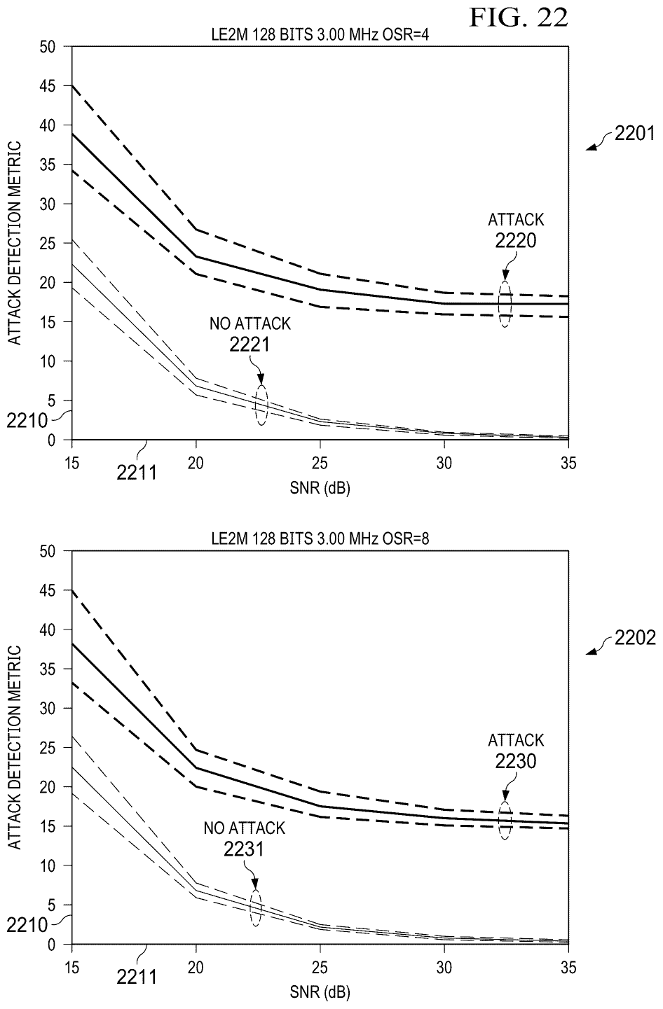

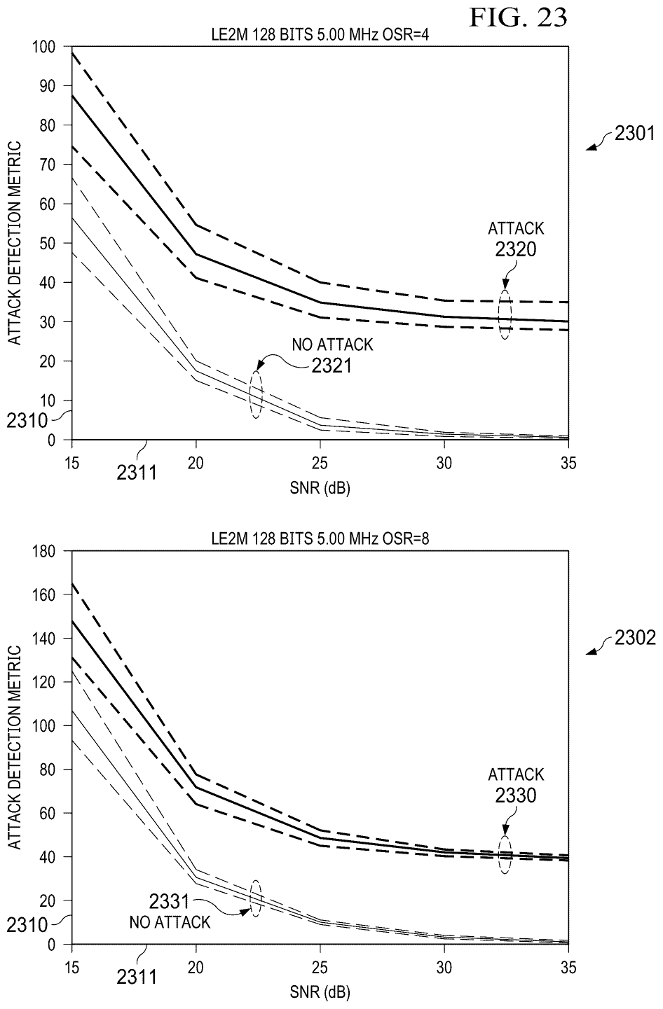

FIGS. 16-23 show NADM curves for a various sets of parameters.

Example embodiments of the present disclosure are summarized here. Other embodiments can also be understood from the entirety of the specification and the claims filed herein.

Example 1. A method, including: receiving, by a first device, a first signal; determining, by the first device, a detection metric indicative of a deviation between the first signal and a reference signal; and performing, by the first device, an action based on the detection metric and a detection threshold level.

Example 2. The method of example 1, further including, comparing the detection metric with the detection threshold level to produce a comparison result, where performing the action based on the detection metric and the detection threshold level includes performing the action based on the comparison result.

Example 3. The method of one of examples 1 or 2, where receiving the first signal includes receiving the first signal during an authentication phase, and where performing the first action includes performing the action based on a successful authentication during the authentication phase.

Example 4. The method of one of examples 1 to 3, further including detecting an anomaly based on the detecting metric and the detection threshold level, where performing the action includes performing the action in response to detecting the anomaly.

Example 5. The method of one of examples 1 to 4, where receiving the first signal includes receiving the first signal from a second device, and where performing the action includes stopping communication between the first device and the second device.

Example 6. The method of one of examples 1 to 5, where receiving the first signal includes receiving the first signal from a second device, and where performing the action includes refusing to perform a vehicle action associated with a vehicle.

Example 7. The method of one of examples 1 to 6, where refusing to perform the vehicle action includes refusing to unlock the vehicle.

Example 8. The method of one of examples 1 to 7, where detecting the anomaly includes detecting the anomaly when the detection metric is higher than the detection threshold level.

Example 9. The method of one of examples 1 to 8, where the reference signal includes a predetermined sequence of bits, and where the first signal includes the predetermined sequence of bits.

Example 10. The method of one of examples 1 to 9, where performing the action includes refusing to perform, by the first device, an unlock operation.

Example 11. The method of one of examples 1 to 10, where performing the action includes providing, by the first device, an indication that the detection metric exceeds the detection threshold level.

Example 12. The method of one of examples 1 to 11, further including performing, by the first device, an unlock action based on the attack detection metric falling below the detection threshold level.

Example 13. The method of one of examples 1 to 12, further including transmitting, by a second device, the first signal.

Example 14. The method of one of examples 1 to 13, where performing, by the first device, the action includes detecting an attack on the first device.

Example 15. The method of one of examples 1 to 14, further including terminating communication between the first device and the second device based on detecting the attack.

Example 16. The method of one of examples 1 to 15, where detecting the attack includes detecting the attack based on the detection metric exceeding the detection threshold level and based on a received signal strength indicator (RSSI) associated with the first signal exceeding a RSSI threshold.

Example 17. The method of one of examples 1 to 16, where detecting the attack includes detecting the attack based on the detection metric exceeding the detection threshold level and based on a signal-to-noise ratio (SNR) associated with the first signal exceeding a SNR threshold.

Example 18. The method of one of examples 1 to 17, where the detection threshold level includes a first value, and where the RSSI threshold includes a second value.

Example 19. The method of one of examples 1 to 18, further including performing, by the first device, an authentication action based on the detection metric falling below the detection threshold level.

Example 20. The method of one of examples 1 to 19, where transmitting, by the second device, the first signal includes transmitting, by the second device, the first signal using a Bandwidth Time (BT) value of 2.0.

Example 21. The method of one of examples 1 to 20, where transmitting, by the second device, the first signal includes transmitting the first signal during a first communication phase, the method further including transmitting, by the second device during a second communication phase, a second signal using a BT value of 0.5.

Example 22. The method of one of examples 1 to 21, where transmitting, by the second device, the first signal includes transmitting the first signal using a Bluetooth LE2M mode.

Example 23. The method of one of examples 1 to 22, where transmitting, by the second device, the first signal includes transmitting the first signal using Bluetooth.

Example 24. The method of one of examples 1 to 23, where transmitting, by the second device, the first signal includes transmitting the first signal using Bluetooth Low Energy (BLE).

Example 25. The method of one of examples 1 to 24, where transmitting, by the second device, the first signal includes transmitting the first signal using Gaussian Frequency Shift Keying (GFSK) modulation.

Example 26. The method of one of examples 1 to 25, further including determining a distance between the first device and the second device based on the first signal.

Example 27. The method of one of examples 1 to 26, further including: determining, by the first device, that the detection metric is below the detection threshold level; determining, by the first device, that the first signal has an associated first SNR that is higher than a predetermined SNR threshold; determining, by the first device, that the distance is below a predetermined distance; and in response to determining that the detection metric is below the detection threshold level, the first SNR is higher than the predetermined SNR threshold, and the distance is below the predetermined distance, performing, by the first device, an unlock operation.

Example 28. The method of one of examples 1 to 27, where the first device is a vehicle or an electronic access control device, where the second device is a smartphone or a key fob, and where performing the unlock operation includes unlocking the first device.

Example 29. The method of one of examples 1 to 28, where the predetermined distance is three meters.

Example 30. The method of one of examples 1 to 29, where the first and second devices are part of an access control system for a room.

Example 31. The method of one of examples 1 to 30, where the first signal includes a round trip time (RTT) packet, the method further including: determining a distance between the first and second devices based on the received RTT packet; and unlocking a vehicle based on the determined distance.

Example 32. The method of one of examples 1 to 31, where determining the distance includes determining the distance based on a phase of a symbol of the RTT packet.

Example 33. The method of one of examples 1 to 32, where performing the action includes detecting, by the first device, an attack based on distortion of the first signal and refusing, by the first device, to perform an unlock action based on detecting the attack.

Example 34. The method of one of examples 1 to 33, where the detection metric includes a Normalized Attack Detection Metric (NADM).

Example 35. The method of one of examples 1 to 34, where determining the detection metric includes determining differences between the first signal and the reference signal and accumulating the differences.

Example 36. The method of one of examples 1 to 35, where determining the detection metric includes determining a mean square error of the first signal relative to the reference signal.

Example 37. A method, including: receiving, by a first device, a first signal from a second device; determining, by the first device, a detection metric indicative of a deviation between the first signal and a reference signal; determining, by the first device, a signal-to-noise ratio (SNR) associated with the first signal; determining that the first signal is authentic when the SNR is higher than an SNR threshold, and the detection metric is lower than a detection threshold; determining that the first signal is not authentic when the detection metric is higher than the detection threshold; in response to determining that the first signal is authentic, performing an unlock operation; and in response to determining that the first signal is not authentic, terminating communication with the second device.

Example 38. The method of example 37, further including determining that the first signal is not authentic when the SNR is lower than the SNR threshold.

Example 39. A device, including: a receiver circuit; and a processor configured to: receive, via the receiver circuit, a first signal; determine an anomaly detection metric associated with the first signal; and perform an action based on the anomaly detection metric exceeding a detection threshold level.

Example 40. A device, including: a receiver circuit; a detection circuit coupled to the receiver circuit; and an action circuit coupled to the detection circuit; where the receiver circuit is configured to receive a first signal; where the detection circuit is configured to determine a detection metric associated with the first signal; and where the action circuit is configured to perform an action based on the detection metric exceeding a detection threshold level.

Example 41. A method, including: identifying, by a first device, a first Bandwidth Time (BT) value; transmitting, by the first device during a first communication phase, a first signal using the first BT value; and transmitting, by the first device during a second communication phase, a second signal using a second BT value, where the second BT value is less than the first BT value.

Example 42. The method of example 41, where transmitting the first signal using the first BT value includes transmitting the first signal in a first communication channel, and where transmitting the second signal using the second BT value includes transmitting the second signal in a second communication channel.

Example 43. A device, including: a transmitter circuit; and a processor configured to: transmit, using the transmitter circuit, a first packet using a first Bandwidth Time (BT) value; and transmit, using the transmitter circuit during a second communication phase, a second packet with a second BT value lower than the first BT value.

Example 44. A method, including: receiving, by a first device a first signal; determining a detection metric associated with the first signal; performing a comparison between the detection metric and a metric threshold level to produce an anomaly result; and detecting, by the first device, an anomaly based on the anomaly result indicating that the detection metric exceeds the metric threshold level.

Example 45. The method of example 44, where: performing the comparison between the detection metric and the metric threshold level includes performing a correlation between the received first signal and a reference signal to generate a correlation result, where the anomaly result is based on the correlation result; and detecting the anomaly based on the anomaly result includes:

Example 46. A method, including: receiving, by a first device, a first signal; determining an attack detection metric associated with the first signal; and detecting, by the first device, an attack based on the attack detection metric exceeding a detection threshold level.

Example 47. A method, including: receiving, by a first device, a first signal; and in response to determining that the first signal deviates from a reference signal by more than a predetermined threshold, performing an action.

Example 48. The method of example 47, further including, calculating a deviation metric indicative of the deviation between the first signal and the reference signal, where determining that the first signal deviates from the reference signal by more than the predetermined threshold includes determining that the first signal deviates from the reference signal by more than the predetermined threshold based on comparing the deviation metric with the predetermined threshold.

Example 49. The method of one of examples 47 or 48, where determining that the first signal deviates from the reference signal by more than the predetermined threshold includes determining that deviation metric is higher than the predetermined threshold.

Example 50. A method including: transmitting, by a first device, an authentication packet during an authentication phase; receiving, by a second device, the authentication packet; determining a Normalized Attack Detection Metric (NADM) associated with the authentication packet; and detecting, by the second device, an attack when the NADM is above a predetermined NADM threshold.

Example 51. The method of example 50, further including, in response to the NADM being below the predetermined NADM threshold, unlocking a vehicle.

Example 52. The method of one of examples 50 or 51, further including refusing to take an action based on detecting the attack.

Example 53. The method of one of examples 50 to 52, where detecting the attack includes detecting the attack when the NADM is above the predetermined NADM threshold and a received signal strength indicator (RSSI) associated with the authentication packet is above a predetermined RSSI threshold.

Example 54. The method of one of examples 50 to 53, where transmitting the authentication packet includes transmitting the authentication packet using BT equal to 2.0, a PN sequence of 128 bits.

Example 55. The method of one of examples 50 to 54, where transmitting the authentication packet includes transmitting the authentication packet using Bluetooth LE2M mode.

Example 56. The method of one of examples 50 to 55, where a receiver bandwidth of the second device is between 3 MHz and 5 MHz.

Example 57. The method of one of examples 50 to 56, where the receiver bandwidth is equal to 4 MHz.

Example 58. The method of one of examples 50 to 57, where transmitting the authentication packet includes transmitting the authentication packet using Bluetooth.

Example 59. The method of one of examples 50 to 58, where the first device is a key fob or smartphone.

Example 60. The method of one of examples 50 to 59, where the second device is a vehicle.

Example 61. A wireless device including a receiver circuit configured to: receive an authentication packet; determine a Normalized Attack Detection Metric (NADM) associated with the authentication packet; and detect an attack when the NADM is above a predetermined NADM threshold.

The above Detailed Description of examples of the technology is not intended to be exhaustive or to limit the technology to the precise form disclosed above. While specific examples for the technology are described above for illustrative purposes, various equivalent modifications are possible within the scope of the technology, as those skilled in the relevant art will recognize. For example, while processes or blocks are presented in a given order, alternative implementations may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed or implemented in parallel or may be performed at different times. Further any specific numbers noted herein are only examples: alternative implementations may employ differing values or ranges.

The teachings of the technology provided herein can be applied to other systems, not necessarily the system described above. The elements and acts of the various examples described above can be combined to provide further implementations of the technology. Some alternative implementations of the technology may include not only additional elements to those implementations noted above, but also may include fewer elements.

These and other changes can be made to the technology in light of the above Detailed Description. While the above description describes certain examples of the technology, and describes the best mode contemplated, no matter how detailed the above appears in text, the technology can be practiced in many ways. Details of the system may vary considerably in its specific implementation, while still being encompassed by the technology disclosed herein. As noted above, particular terminology used when describing certain features or aspects of the technology should not be taken to imply that the terminology is being redefined herein to be restricted to any specific characteristics, features, or aspects of the technology with which that terminology is associated. In general, the terms used in the following claims should not be construed to limit the technology to the specific examples disclosed in the specification, unless the above Detailed Description section explicitly defines such terms. Accordingly, the actual scope of the technology encompasses not only the disclosed examples, but also all equivalent ways of practicing or implementing the technology under the claims.

While this disclosure has been described with reference to illustrative embodiments, this description is not limiting. Various modifications and combinations of the illustrative embodiments, as well as other embodiments, will be apparent to persons skilled in the art upon reference to the description.

What is claimed is:

1. A method, comprising:
receiving, by a first device, a first signal;
determining, by the first device, a detection metric indicative of a deviation between the first signal and a reference signal; and
performing, by the first device, an action based on the detection metric and a detection threshold level.

2. The method of claim 1, further comprising, comparing the detection metric with the detection threshold level to produce a comparison result, wherein performing the action based on the detection metric and the detection threshold level comprises performing the action based on the comparison result.

3. The method of claim 1, wherein receiving the first signal comprises receiving the first signal during an authentication phase, and wherein performing the first action comprises performing the action based on a successful authentication during the authentication phase.

4. The method of claim 1, further comprising detecting an anomaly based on the detecting metric and the detection threshold level, wherein performing the action comprises performing the action in response to detecting the anomaly.

5. The method of claim 4, wherein receiving the first signal comprises receiving the first signal from a second device, and wherein performing the action comprises stopping communication between the first device and the second device.

6. The method of claim 4, wherein detecting the anomaly comprises detecting the anomaly when the detection metric is higher than the detection threshold level.

7. The method of claim 6, wherein the reference signal comprises a predetermined sequence of bits, and wherein the first signal comprises the predetermined sequence of bits.

8. The method of claim 1, further comprising performing, by the first device, an unlock action based on the attack detection metric falling below the detection threshold level.

9. The method of claim 1, further comprising transmitting, by a second device, the first signal.

10. The method of claim 9, wherein detecting the attack comprises detecting the attack based on the detection metric exceeding the detection threshold level and based on a received signal strength indicator (RSSI) associated with the first signal exceeding a RSSI threshold.

11. The method of claim 10, wherein detecting the attack comprises detecting the attack based on the detection metric exceeding the detection threshold level and based on a signal-to-noise ratio (SNR) associated with the first signal exceeding a SNR threshold.

12. The method of claim 9, wherein transmitting, by the second device, the first signal comprises transmitting, by the second device, the first signal using a Bandwidth Time (BT) value of 2.0.

13. The method of claim 12, wherein transmitting, by the second device, the first signal comprises transmitting the first signal during a first communication phase, the method further comprising transmitting, by the second device during a second communication phase, a second signal using a BT value of 0.5.

14. The method of claim 9, wherein transmitting, by the second device, the first signal comprises transmitting the first signal using a Bluetooth LE2M mode.

15. The method of claim 9, wherein transmitting, by the second device, the first signal comprises transmitting the first signal using Bluetooth Low Energy (BLE).

16. The method of claim 9, wherein transmitting, by the second device, the first signal comprises transmitting the first signal using Gaussian Frequency Shift Keying (GFSK) modulation.

17. The method of claim 9, further comprising determining a distance between the first device and the second device based on the first signal.

18. The method of claim 17, further comprising:
determining, by the first device, that the detection metric is below the detection threshold level;
determining, by the first device, that the first signal has an associated first SNR that is higher than a predetermined SNR threshold;
determining, by the first device, that the distance is below a predetermined distance; and
in response to determining that the detection metric is below the detection threshold level, the first SNR is higher than the predetermined SNR threshold, and the distance is below the predetermined distance, performing, by the first device, an unlock operation.

19. The method of claim 18, wherein the first device is a vehicle or an electronic access control device, wherein the second device is a smartphone or a key fob, and wherein performing the unlock operation comprises unlocking the first device.

20. The method of claim 8, wherein the first signal comprises a round trip time (RTT) packet, the method further comprising:
determining a distance between the first and second devices based on the received RTT packet; and
unlocking a vehicle based on the determined distance.

21. The method of claim 20, wherein determining the distance comprises determining the distance based on a phase of a symbol of the RTT packet.

22. The method of claim 20, wherein performing the action comprises detecting, by the first device, an attack based on distortion of the first signal and refusing, by the first device, to perform an unlock action based on detecting the attack.

23. The method of claim 1, wherein determining the detection metric comprises determining differences between the first signal and the reference signal and accumulating the differences.

24. The method of claim 1, wherein determining the detection metric comprises determining a mean square error of the first signal relative to the reference signal.
